(19) United States
(12) Patent Application Publication
(10) Pub. No.: US 2026/0334490 A1
(43) Pub. Date: Oct. 29, 2026

(54) FOOD PRODUCTS AND SYSTEMS AND METHODS OF MAKING SAME

(71) Applicant: Land O'Lakes, Inc., Arden Hills, MN (US)

(72) Inventors: Thomas Alexander Glenn, III, Arden Hills, MN (US); Leah T. Blasing, Arden Hills, MN (US)

(21) Appl. No.: 19/698,734

(22) Filed: Jun. 4, 2026

Related U.S. Application Data
(63) Continuation of application No. PCT/US2024/057767, filed on Nov. 27, 2024.
(60) Provisional application No. 63/608,951, filed on Dec. 12, 2023.
(60) Provisional application No. 63/608,961, filed on Dec. 12, 2023.
(60) Provisional application No. 63/608,971, filed on Dec. 12, 2023.
(60) Provisional application No. 63/608,985, filed on Dec. 12, 2023.
(60) Provisional application No. 63/609,004, filed on Dec. 12, 2023.
(60) Provisional application No. 63/609,024, filed on Dec. 12, 2023.
(60) Provisional application No. 63/665,388, filed on Jun. 28, 2024.

(51) Int. Cl. A23C 9/123; A23C 9/142; A23C 19/032; A23C 19/05; A23C 19/09

(52) U.S. Cl. CPC A23C 9/123; A23C 9/1422; A23C 19/0323; A23C 19/054; A23C 19/0904; A23C 2210/202; A23V 2400/215; A23V 2400/231

(57) ABSTRACT

Production of dairy products involves adjusting a composition of milk such that an adjusted milk composition contains a reduced protein-to-fat ratio or a reduced lactose-to-fat ratio relative to the composition of the milk. The adjusted milk composition is fermented to cause in situ production of lactic acid during a fermentation period of about 4 hours to about 22 hours. During the fermentation period, a pH range of about 5.5 to about 5.9 is maintained by adding a pH adjuster to the fermenting adjusted milk composition, resulting in increased lactic acid production compared to fermentation without pH maintenance. An antimicrobial may be produced by an antimicrobial-producing culture, such as a nisin-producing culture. The adjusted milk composition may be a microfiltration concentrate from which whey has been removed. The methods may include pH-controlled fermentation, enzyme treatment, and split-fed batch processing, and may be performed in a continuous, nearly continuous, or semi-continuous manner.

### CROSS-REFERENCE TO RELATED APPLICATIONS

This application is a continuation of International Patent Application No. PCT/US2024/057767, filed Nov. 27, 2024, entitled “FOOD PRODUCTS AND SYSTEMS AND METHODS OF MAKING SAME”, which in turn claims priority to U.S. Provisional Patent Application No. 63/608,951, filed Dec. 12, 2023, entitled “FOOD PRODUCTS AND SYSTEMS AND METHODS OF MAKING SAME,” and U.S. Provisional Patent Application No. 63/608,961, filed Dec. 12, 2023, entitled “FOOD PRODUCTS AND SYSTEMS AND METHODS OF MAKING SAME”, and U.S. Provisional Patent Application No. 63/608,971, filed Dec. 12, 2023, entitled “FOOD PRODUCTS AND SYSTEMS AND METHODS OF MAKING SAME”, and U.S. Provisional Patent Application No. 63/608,985, filed Dec. 12, 2023, entitled “FOOD PRODUCTS AND SYSTEMS AND METHODS OF MAKING SAME”, and U.S. Provisional Patent Application No. 63/609,004, filed Dec. 12, 2023, entitled “FOOD PRODUCTS AND SYSTEMS AND METHODS OF MAKING SAME”, and U.S. Provisional Patent Application No. 63/609,024, filed Dec. 12, 2023, entitled “FOOD PRODUCTS AND SYSTEMS AND METHODS OF MAKING SAME”, and U.S. Provisional Patent Application No. 63/665,388, filed Jun. 28, 2024, entitled “FLAVOR CHEESE PRODUCTS, FOOD PRODUCTS CONTAINING SUCH FLAVOR CHEESE PRODUCTS AND SYSTEMS AND METHODS OF MAKING SAME”, each of which is incorporated by reference herein, in the entirety and for all purposes.

### TECHNICAL FIELD

Dairy products and systems and methods for production of such dairy products are disclosed.

### BACKGROUND

Bacterial fermentation of lactose in a dairy-derived starting material produces lactic acid and an attendant decrease in pH. Ingredients such as preservatives and emulsifiers are typically added to dairy products to maintain the desired characteristics, including desired flavor, aroma, appearance, consistency, texture, and./or meltability, of dairy products throughout their shelf life.

Dairy product producers continue to seek improved methods of production. Consumers continue to seek dairy products with fewer, and fewer artificial, added ingredients.

### SUMMARY

In some aspects, the present disclosure relates to a method of producing a dairy product. The method may comprise adjusting a composition of milk such that an adjusted milk composition contains at least one of a reduced protein-to-fat ratio or a reduced lactose-to-fat ratio relative to the composition of the milk. The method may further comprise fermenting the adjusted milk composition to cause in situ production of lactic acid during a fermentation period of about 4 hours to about 22 hours. During the fermentation period, a pH range of about 5.5 to about 5.9 may be maintained by adding a pH adjuster to the fermenting adjusted milk composition. In some aspects, more lactic acid may be produced during the fermentation period than in the absence of maintaining the pH range at about 5.5 to about 5.9.

In some aspects, the pH may be maintained at about 5.7 to about 5.9. The pH adjuster may be at least one of a sodium hydroxide solution or a potassium hydroxide solution. In some cases, prior to adding the pH adjuster, a portion of the fermenting adjusted milk composition may be withdrawn and combined with the pH adjuster, and the combination may be added to a remaining portion of the fermenting adjusted milk composition via an in-line recirculation loop.

In some aspects, during the fermenting, an antimicrobial may be produced by an antimicrobial-producing culture. More antimicrobial may be produced during the fermentation period than in the absence of maintaining the pH range at about 5.5 to about 5.9. The antimicrobial-producing culture may comprise a nisin-producing culture, and during the fermenting, nisin may be produced at a level of about 4 ppm to about 35 ppm. In some cases, the antimicrobial-producing culture may be the sole preservative in the dairy product.

In some aspects, during the fermenting, the lactic acid may be produced at a level of about 0.25 wt % to about 2.3 wt %. The lactic acid may be produced by at least one nisin-producing culture. In some cases, the lactic acid may be produced by both a nisin-producing culture and a starter culture.

In some aspects, the adjusted milk composition may be a microfiltration concentrate having the reduced protein-to-fat ratio. Prior to or during the fermenting, lactose may be added to the adjusted milk composition. Prior to the fermenting, the adjusted milk composition may be salted. In some cases, prior to the fermenting, the adjusted milk composition may be heat treated to a temperature of about 155 °F to about 175 °F and then cooled to a temperature of about 70 °F to about 94 °F. The dairy product may be free of emulsifying salts.

In some aspects, the present disclosure relates to a method of producing a dairy product comprising adjusting a composition of milk such that an adjusted milk composition contains at least one of a reduced protein-to-fat ratio or a reduced lactose-to-fat ratio relative to the composition of the milk, and fermenting the adjusted milk composition to cause in situ production of lactic acid during a fermentation period of at least about 4 hours. During the fermentation period, a pH range of about 5.5 to about 5.9 may be maintained by adding a pH adjuster to the fermenting adjusted milk composition. The adjusted milk composition may be a microfiltration concentrate having the reduced protein-to-fat ratio, and at least a portion of whey may have been removed from the adjusted milk composition. Prior to adding the pH adjuster, a portion of the fermenting adjusted milk composition may be withdrawn and combined with the pH adjuster, and the pH-adjusted combination may be added to a remaining portion of the fermenting adjusted milk composition.

According to additional implementations, a method of producing a dairy product may involve adjusting a composition of milk such that an adjusted milk composition contains at least one of a reduced protein-to-fat ratio or a reduced lactose-to-fat ratio relative to the composition of the milk; and fermenting the adjusted milk composition to cause in situ production of lactic acid. During the fermenting, a pH range of about 5.5 to about 5.9 is maintained by adding a pH adjuster to the fermenting adjusted milk composition.

In some cases, the pH is maintained at about 5.7 to about 5.9; and/or the pH adjuster may be at least one of a sodium hydroxide solution or a potassium hydroxide solution; and/or the pH adjuster may be added via an in-line recirculation loop.

In some examples, during the fermenting, an antimicrobial is produced by an antimicrobial-producing culture, and for instance, more antimicrobial may be produced than in the absence of maintaining the pH range at about 5.5 to about 5.9. In some instances, the antimicrobial-producing culture includes a nisin-producing culture, and during the fermenting, nisin may be produced at a level of about 4 ppm to about 35 ppm. In some cases, the antimicrobial-producing culture is the sole preservative in the dairy product.

In some examples, more of the lactic acid is produced than in the absence of maintaining the pH range at about 5.5 to about 5.9; and/or during the fermenting, the lactic acid is produced at a level of about 0.25 wt % to about 2.3 wt %; and/or the lactic acid is produced by at least one nisin-producing culture; and/or the lactic acid is produced by both a nisin-producing culture and a starter culture.

In some cases the adjusted milk composition is a microfiltration concentrate having the reduced protein-to-fat ratio; and/or prior to or during the fermenting, lactose and/or salt is added to the adjusted milk composition.

In some implementations, prior to the fermenting, the adjusted milk composition is heat treated to a temperature of about 155 °F to about 175 °F and then cooled to a temperature of about 70 °F to about 94 °F.

According to other implementations, a method of producing a dairy product may involve adjusting a composition of milk and fermenting the adjusted milk composition to cause in situ production of lactic acid during a fermentation period of at least about 4 hours. During fermenting, a pH range of about 5.5 to about 5.9 may be maintained by adding a pH adjuster to the fermenting adjusted milk composition.

In such cases, the adjusted milk composition may be a microfiltration concentrate having the reduced protein-to-fat ratio; and/or at least a portion of the whey has been removed from the adjusted milk composition.

A method of producing a dairy product, in further implementations, may involve the adjusting of a composition of milk and fermenting the adjusted milk composition to cause in situ production of lactic acid during a fermentation period of at least about 4 hours.

In such cases, the adjusting of the composition of the milk may involve removing a portion of whey protein from the milk, such as by one or more of microfiltration, diafiltration, ion exchange, and vat removal, and more particularly by microfiltration and diafiltration. The adjusting of the composition of the milk may also involve removing a portion of lactose from the milk; and/or removing a portion of milk minerals, and adding a portion of the removed milk minerals to the product. For instance, one or more of phosphate or citrate derived from the milk minerals may be added to the product.

Adjusting of the composition of the milk may involve adding one or more of fat and casein protein to the milk; and/or prior to the adjusting, the method may further involve a step of standardizing the milk with added cream, and for instance the milk may be whole milk, and in some cases the standardized milk may be subjected to pasteurizing.

In examples, during the fermenting, nisin is produced at a concentration of about 4 ppm to about 35 ppm. For instance, the nisin may be produced by at least one nisin-producing culture. In addition or alternatively, during the fermenting, the lactic acid is produced at a concentration of about 0.25 wt % to about 2.3 wt %, or at a concentration of about 0.25 wt % to about 1.4 wt %. In some cases, the lactic acid is produced by at least one nisin-producing culture; or the lactic acid is produced by both a nisin-producing culture and a starter culture.

In examples, during the fermenting, a pH value of the adjusted milk composition is allowed to fall without intervention. For instance, the pH may fall to about 4.9 to about 5.4. The fermenting may be allowed to go to completion.

In examples, prior to or during the fermenting, lactose is added to the adjusted milk composition.

In various implementations, at least one lactic acid-producing culture is added during the fermenting; and/or prior to the fermenting, the adjusted milk composition is salted; and/or prior to the fermenting, the adjusted milk composition is heat treated to a temperature of about 155 °F to about 175 °F and then cooled to a temperature of about 70 °F to about 94 °F; and/or nisin produced by a nisin-producing culture during the fermenting is the sole preservative in the dairy product.

The adjusted milk composition may be a microfiltration concentrate having the reduced protein-to-fat ratio; and/or at least a portion of the whey may have been removed from the adjusted milk composition.

Another method of producing a dairy product, in implementations, may involve the adjusting of a composition of milk, fermenting the adjusted milk composition to cause in situ production of lactic acid, and adding an enzyme, the enzyme including at least one of a phospholipase or a glutaminase, to the adjusted milk composition. The dairy product may be free of emulsifying salts or contains lower amounts of emulsifying salts than in the absence of the enzyme.

In examples, the enzyme may be added during the fermenting, and in such cases, the fermenting may produce a fermentate that is heated to cease enzyme activity. In addition or alternatively, the dairy product may be free of emulsifying salts, and for instance, the dairy product, for the duration of its shelf life, is as stable as a dairy product that includes emulsifying salts but excludes the enzyme, and for example, the shelf life may be about 36 weeks.

In examples, the phospholipase may facilitate the interaction of fat globules and milk proteins in the adjusted milk composition to help stabilize the dairy product; and/or the glutaminase may facilitate the interaction of protein-bound amino acids and fats in the adjusted milk composition to help stabilize the dairy product; and/or the glutaminase may facilitate the interaction of free amino acids and water in the adjusted milk composition to help stabilize the dairy product.

Prior to the fermenting, the adjusted milk composition may be salted and/or the adjusted milk composition may be heated to a temperature of about 155 °F to about 175 °F and then cooled to a temperature of about 70 °F to about 94 °F.

The adjusted milk composition may be a microfiltration concentrate having the reduced protein-to-fat ratio, and for instance at least a portion of the whey has been removed from the adjusted milk composition.

An exopolysaccharide may be produced in the various fermentates.

Yet another method of producing a dairy product, in implementations, may involve the adjusting of a composition of milk; fermenting the adjusted milk composition to cause in situ production of lactic acid, and during the fermenting, a pH range of about 5.5 to about 5.9 is maintained by adding a pH adjuster to the fermenting adjusted milk composition; and adding an enzyme. The dairy product may be free of emulsifying salts or contain lower amounts of emulsifying salts than in the absence of the enzyme.

In examples, the adjusting of the composition of the milk may involve removing a portion of whey protein from the milk, for instance by one or more of microfiltration, diafiltration, ion exchange, and vat removal, more particularly by microfiltration and diafiltration. The adjusting of the composition of the milk may further involve removing a portion of lactose from the milk; and/or removing a portion of milk minerals, and adding a portion of the removed milk minerals to the product, for instance by adding one or more of phosphate or citrate derived from the milk minerals are added to the product.

In examples, salt may be added to the adjusted milk composition prior to the fermenting and the fermenting is by a cheese culture; one or more natural flavors may be added to the dairy product after the adding of the enzyme; the enzyme-treated dairy product containing the salt and the one or more natural flavors may be subjected to a heat treatment to at least pasteurization temperatures; and the pasteurized dairy product may be packaged such that it has a composition of pasteurized milk, the cheese culture, the enzyme, the salt, and the one or more natural flavors.

In some cases, the adjusting of the composition of the milk may involve adding one or more of fat and casein protein to the milk. In addition or alternatively, prior to the adjusting, the method may further involve a step of standardizing the milk with the added cream. In some cases, the milk is whole milk. In some cases, the standardized milk may be pasteurized.

In various implementations and alternatives, fermenting further causes in situ production of an antimicrobial to thereby produce an antimicrobial-containing product; and the method may further involve packaging the product such that the cheese product is formed solely of the nisin-containing product. For instance, the cheese product may include nisin as the antimicrobial with a level of at least 4 ppm of nisin. In some cases, the method may further involve heat treating or pasteurization of the cheese product.

In various implementations and alternatives, emulsifying salts may be added to form a mixture, and the fermenting may further cause in situ production of an antimicrobial to thereby produce an antimicrobial-containing product; and the mixture may be subjected to cooking to form one or more of a cheese sauce, a process cheese, or a process cheese spread, and the cheese product may retain the composition of the antimicrobial-containing product. For instance, the cheese production method may result in the cheese product being free of added preservatives. Methods may further involve injecting steam during cooking and/or removing moisture. For instance, removal of moisture may involve one or more of reverse osmosis and wiped film evaporation.

In examples, a pH is maintained at about 5.7 to about 5.9, and/or the pH adjuster is a sodium hydroxide solution, and/or the pH adjuster is added via an in-line recirculation loop.

In various implementations and alternatives, the fermenting further causes in situ production of nisin, and more of the nisin is produced than in the absence of maintaining the pH range at about 5.5 to about 5.9. In some cases, during the fermenting, the nisin is produced at a level of about 4 ppm to about 35 ppm. In some cases, more of the lactic acid is produced than in the absence of maintaining the pH range at about 5.5 to about 5.9; and/or during the fermenting, the lactic acid is produced at a level of about 0.25 wt % to about 2.3 wt %; and/or the fermenting is performed for at least about 14 hours.

In some cases, the enzyme is added during the fermenting. A protein glutaminase may be added to the adjusted milk composition having a pH of about 5.8. Fermenting may in situ production of nisin, and the nisin may be the sole preservative in the dairy product.

A label for the dairy product may include no more than pasteurized milk, pasteurized cultured milk, or heat-treated milk, natural flavor, salt, cheese cultures, and enzymes. A label for the dairy product may include no milk component other than pasteurized milk, pasteurized cultured milk, or heat-treated milk.

The adjusted milk composition may be a microfiltration concentrate having the reduced protein-to-fat ratio. At least a portion of the whey may have been removed from the adjusted milk composition.

A further method of producing a dairy product, in implementations, may involve adjusting of a composition of milk; fermenting a first portion of the adjusted milk composition to cause in situ production of lactic acid and an antimicrobial; fermenting a second portion of the adjusted milk composition to cause in situ production of lactic acid; and combining the first portion and the second portion to produce the dairy product.

The lactic acid in the second portion may be produced by an antimicrobial-sensitive culture. In addition or alternatively, an exopolysaccharide is produced in the second portion, an antimicrobial may be produced in situ in the second portion, and/or an enzyme may be added to the second portion such as a phospholipase and/or a glutaminase. In some cases an enzyme may be added to the first portion, and the enzyme may be different than the enzyme added to the second portion. In addition or alternatively, a protease may be added to at least one of the first portion or the second portion. The protease may decrease a level of whey protein in the at least one of the first portion or the second portion.

Lactose may be added to at least one of the first portion and the second portion, and for instance, the lactose added to the first portion is in an amount that is different from the amount added to the second portion.

A pH range of about 5.4 to about 5.8 may be maintained in the first portion of the adjusted milk composition. The pH range may be maintained by circulating a pH adjuster in the first portion of the adjusted milk composition. A pH of the fermenting first portion may be different than the pH of the fermenting second portion.

A temperature of the fermenting first portion may be different than a temperature of the fermenting second portion.

The various dairy products may be free of emulsifying salts, added lactic acid, added flavor-producing compounds and/or added preservatives; and/or the antimicrobial may be the sole preservative.

The various methods may further involve packaging the dairy product, and the dairy product may include no more than pasteurized milk, pasteurized cultured milk, or heat-treated milk, natural flavor, salt, cheese cultures, and enzymes.

The various methods may further involve packaging the dairy product, and the dairy product may include no milk component other than pasteurized milk, pasteurized cultured milk, or heat-treated milk.

The methods may be a continuous, nearly continuous, or semi-continuous.

### BRIEF DESCRIPTION OF THE DRAWINGS

FIGS. 1A-1D are schematics of methods disclosed herein.

FIG. 2 is a schematic of methods disclosed herein, including split-fed batch processing.

FIGS. 3A and 3B are schematics of methods of making cheese sauce products according to embodiments disclosed herein.

FIG. 4 is a schematic of a method of making process cheese products according to embodiments disclosed herein.

FIG. 5 is a line graph showing lactic acid production according to implementations disclosed herein.

FIG. 6 is a lines graph showing the pH and nisin content over time of fermentates produced according to implementations disclosed herein.

FIG. 7 is a bar graph showing nisin production according to implementations disclosed herein.

FIG. 8 is a bar graph showing amounts of nisin (ppm) fermentate samples over 36 weeks according to implementations disclosed herein.

### DETAILED DESCRIPTION

The present disclosure is directed to dairy products and methods and systems for producing such products. In the disclosed methods and systems, a substantial portion of the product formulation is derived directly from milk. The product formulations or portions thereof may be processed in a batch, continuous, nearly continuous, or semi-continuous manner. Dairy products may include cheese products such as cheese sauces, heat-treated cheese sauces, pasteurized cheese sauces, process cheese, pasteurized process cheese, dairy spreads, pasteurized process cheese spreads, pasteurized process cheese products, and precursors or intermediates to production of any of the foregoing.

Milk compositions used in producing the dairy products of the present disclosure may include liquid whole milk, reduced fat milk, skim milk, cream, ultrafiltered milk, microfiltered milk, buttermilk, condensed skim milk, condensed whole milk, condensed buttermilk, or mixtures thereof, in liquid or dried forms and rehydrated mixtures thereof. Additionally or alternatively the milk be pasteurized. Additionally or alternatively the milk be concentrated liquid milk. Any disclosed dairy product may exclude one or more of the foregoing milk forms. For example, a disclosed dairy product may be free of skim milk.

The milk compositions may be pasteurized and/or standardized. Pasteurization of milk involves heating the milk at temperatures and holding times that destroy pathogens, such as Listeria and Salmonella, present in raw milk. For example, pasteurization may be conducted at 145 °F for 30 minutes or at greater than or equal to 161 °F for 15 seconds. Pasteurization may be performed prior to further adjustment or processing, as described below. Standardization of milk may involve the addition of cream to reach a target fat-to-protein ratio. In some examples, a blend of milk (e.g., raw milk) and cream and/or skim milk may be pasteurized and cooled to approximately 130 °F before further processing of the milk composition, as described below.

### Adjustment of Milk Compositions

The starting milk compositions disclosed herein may be subjected to a milk composition adjustment process, such as by removing at least a portion of one or more milk components. For example, protein, protein-containing components (e.g., whey and casein), fat, lactose, minerals, solids nonfat, water, or combinations thereof, may be removed from the milk composition. Adjustment processes to produce adjusted milk compositions may include but are not limited to microfiltration, ion exchange, centrifugation, vat processing, enzyme treatment, ultrafiltration, reverse osmosis, nanofiltration, and evaporation, and addition of dairy components each as described in more detail herein.

The milk composition adjustment processes may remove at least a portion of the aforementioned milk components while retaining others. For example, removal of at least a portion of one or more milk components from the milk composition may prepare a dairy stream for subsequent processing steps in which retention of the remaining milk components is desired through the production process. In some cases, the remaining milk components may be retained in an intermediate product, or both in the intermediate and a final product. In some embodiments, the adjustment process may remove at least a portion of whey protein and/or lactose from the milk compositions. For instance, the adjusted milk composition may have both a reduced protein-to-fat ratio and a reduced lactose-to-fat ratio relative to starting milk composition. As disclosed herein, removal of at least a portion of the whey protein may help produce final products with improved properties compared to final products that retain more whey proteins. Removal of whey protein while retaining fat may prepare the dairy stream for production of dairy products with an adjusted ratio, e.g., a reduced protein-to-fat ratio or a higher fat-to-protein ratio. Removal of at least a portion of lactose from the milk compositions may prepare the dairy stream for further processing steps, as disclosed herein. Removal of lactose while retaining fat may also prepare the dairy stream for production of dairy products with an adjusted nutrient ratio, e.g., a reduced lactose-to-fat ratio or a higher fat-to-lactose ratio. Removal of at least a portion of fat from the milk compositions may prepare the dairy stream for production of dairy products with an adjusted, e.g., a higher, protein-to-fat ratio. Removal of at least a portion of the water from the milk compositions such as through evaporation, microfiltration or ultrafiltration may prepare the milk stream for further processing, as disclosed herein.

### Microfiltration

Microfiltration of milk results in removal of whey protein (e.g., serum protein), lactose, water, and minerals. For example, microfiltration of whole milk results in retention of native milk fat globules along with other milk components while removing at least a portion of the whey, lactose, and minerals via the permeate stream, which may provide improved dairy products as disclosed herein. Adjusting the milk composition via microfiltration may additionally involve one or more diafiltration steps based on the desired level of extraction of the whey protein and lactose. For example, water may be added to the microfiltered retentate before subsequent filtration to further reduce the concentration of lactose and minerals. The number of diafiltration steps may depend on the desired properties of the microfiltration retentate and the final product. The adjusted milk composition may thus be the retentate of the microfiltration and optional diafiltration steps and may include fat, and a portion of the initial protein, lactose, mineral, and moisture content from the milk. The milk may be non-acidified or acidified prior to filtration, such as by the addition of edible acids or enzymes such as citric acid, acetic acid, lactic acid, protease, carbon dioxide, or lipase. Acidification of milk prior to microfiltration may result in an increased amount of calcium being transferred to the permeate. Microfiltration may be conducted at about 120 °F to about 140 °F, such as about 125 °F to about 135 °F.

### Ion Exchange

Ion exchange may be used to remove select ions from the milk composition and/or concentrate selections in the milk composition. Accordingly, ion exchange processes may be used to form ion-depleted or ion-enriched milk compositions. The milk composition may be loaded on to an ion-exchange column to bind and/or pass select cations or anions. For example, any one or more of calcium, sodium, potassium, chloride, phosphate, and citrate may be bound to or passed through an ion exchange column. When a desired ion is bound to a column, it may be eluted with an eluent and collected. In addition or alternatively, nanofiltration may be used to remove ions from the milk composition and/or concentrate select ions in the milk composition. Whey protein may also be removed via ion exchange.

### Centrifugation

Centrifugation may be used to remove fat from the milk composition and/or concentrate select ions in the milk composition.

### Vat Removal

Vat processing may involve adding cultures or enzymes (e.g., rennet) to milk in a vat where the cultures and/or enzymes cause a physical phase change, e.g., coagulation of the milk, and whey may be separated from the curd. For instance, whey protein may be removed from milk by vat removal.

### Enzyme Treatment

Enzymes may convert lactose to galacto-oligosaccharides and monosaccharaides. For instance, lactase, may be added to milk compositions to hydrolyze lactose into its constituent sugars-glucose and galactose. As provided herein, some lactose in the component-adjusted milk may be retained, and the enzymatic activity may be controlled by, for example, heat treatment to denature the enzyme prior to complete hydrolysis of the lactose. In addition or alternatively, lactase treatment at reduced temperatures and/or at a reduced pH may slow lactose conversion.

### Ultrafiltration

Ultrafiltration may remove at least some moisture, minerals and lactose from a milk composition while retaining all proteins, including whey proteins, as well as fat. Consequently, in ultrafiltration of milk, the ratio of fat:asein:whey protein is the same as that in milk. Similarly, performing other milk composition adjustment processes to produce an adjusted milk composition prior to ultrafiltration may result in retention of the same protein and fat ratios as in the adjusted milk composition. For example, where whey and lactose are removed in an adjustment process such as microfiltration, a subsequent step of ultrafiltration may maintain the same ratio of protein and fat from the microfiltration retentate while removing a portion of moisture and lactose.

### Reverse Osmosis

Reverse osmosis removes at least some moisture, from a milk composition while retaining other components. Accordingly, reverse osmosis may help produce concentrated milk compositions in which the total solids concentration has been increased. For example, reverse osmosis may produce a concentrated milk composition having about 25 wt % to 30 wt % total solids.

### Nanofiltration

Nanofiltration removes at least some moisture and minerals and salts from a milk composition while retaining other components. Accordingly, nanofiltration may help produce concentrated milk compositions in which the total solids concentration has been increased. For example, nanofiltration may produce a concentrated milk composition having about 25 wt % to 30 wt % total solids.

### Evaporation

Evaporation removes at least some moisture from a milk composition while retaining all other components. Accordingly, evaporation may help produce concentrated milk compositions in which the total solids concentration has been increased.

### Addition of Dairy Components

In further implementations, the milk composition may be adjusted by adding dairy components to the composition. For example, one or more of protein, protein-containing components (e.g., whey and casein), fat, lactose, solids nonfat, milk protein concentrate (MPC), and water, or combinations thereof, may be added to the starting milk composition to produce an adjusted milk composition that differs from the starting milk composition.

Accordingly, implementations may involve adjusting a milk composition such that an adjusted milk composition contains different ratios of milk components compared to the original milk composition. For example, the adjusted milk composition may have a reduced protein-to-fat ratio and/or a reduced lactose-to-fat ratio relative to the starting milk composition, such as whole milk.

Each adjustment process may be conducted at a suitable temperature and pressure, which may be an elevated temperature and/or pressure. For example, an adjustment process may be performed at about 125 °F to about 180 °F, about 155 °F to about 175 °F, about 140 °F to about 170 °F, about 140 °F to about 180 °F, or about 160 °F to about 180 °F. An adjustment process may be performed at about 24 to about 29.5 inHg (inches of mercury), vacuum. In some implementations, the adjustment process may additionally include cooling the adjusted milk composition to a temperature of about 70 °F to about 94 °F. Adjustment through filtration may be up to 100 psig (gauge pressure), but may also be conducted at lower pressure while simultaneously achieving adjustment through evaporation.

### Example Process

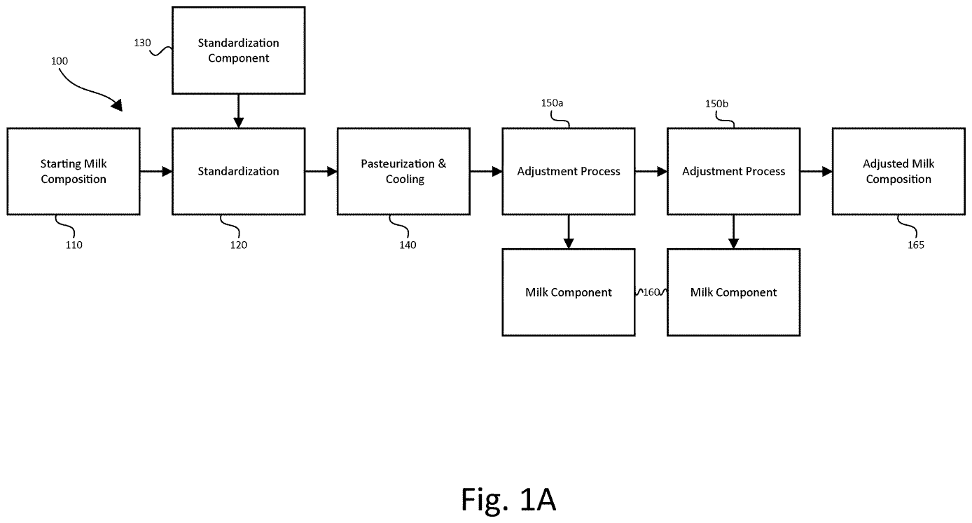

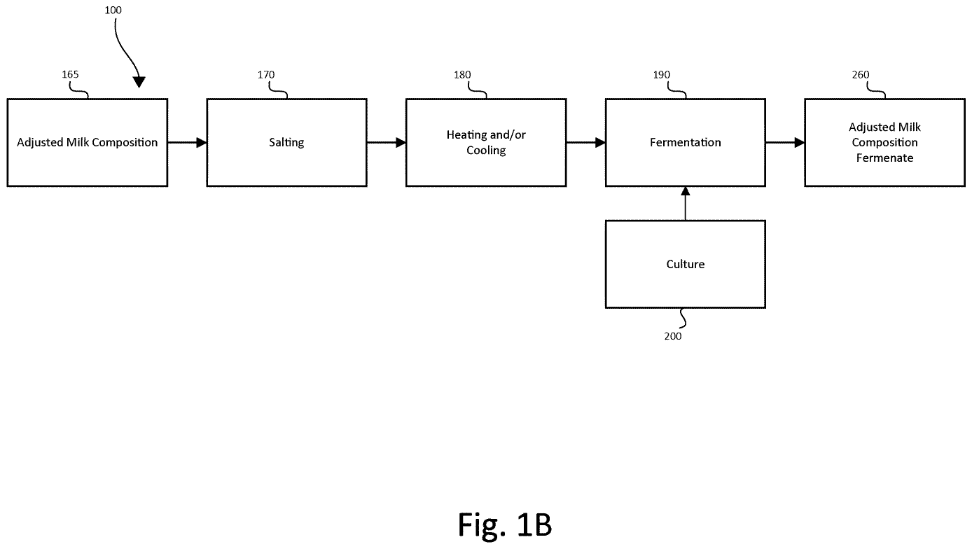

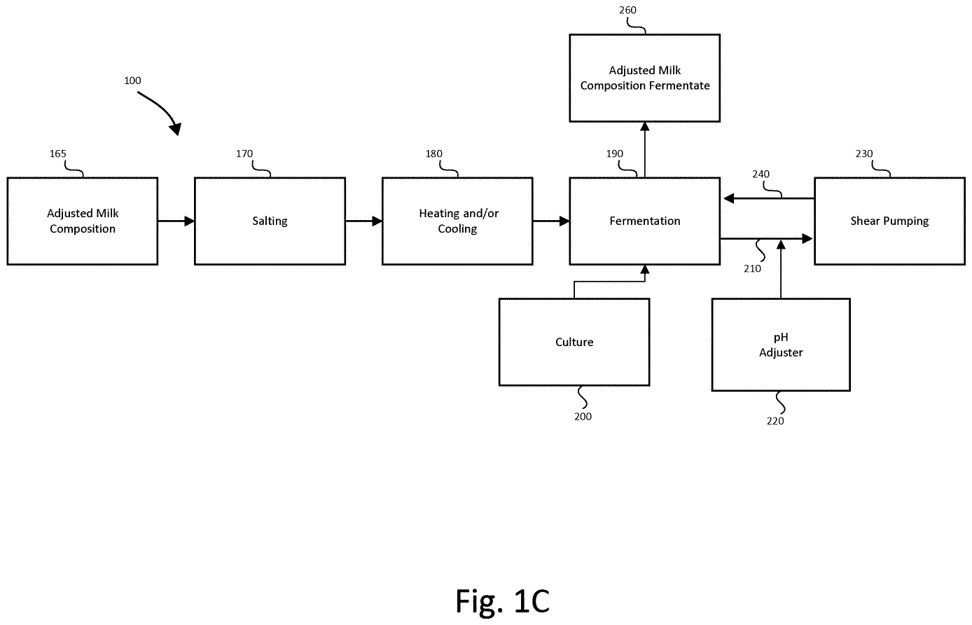

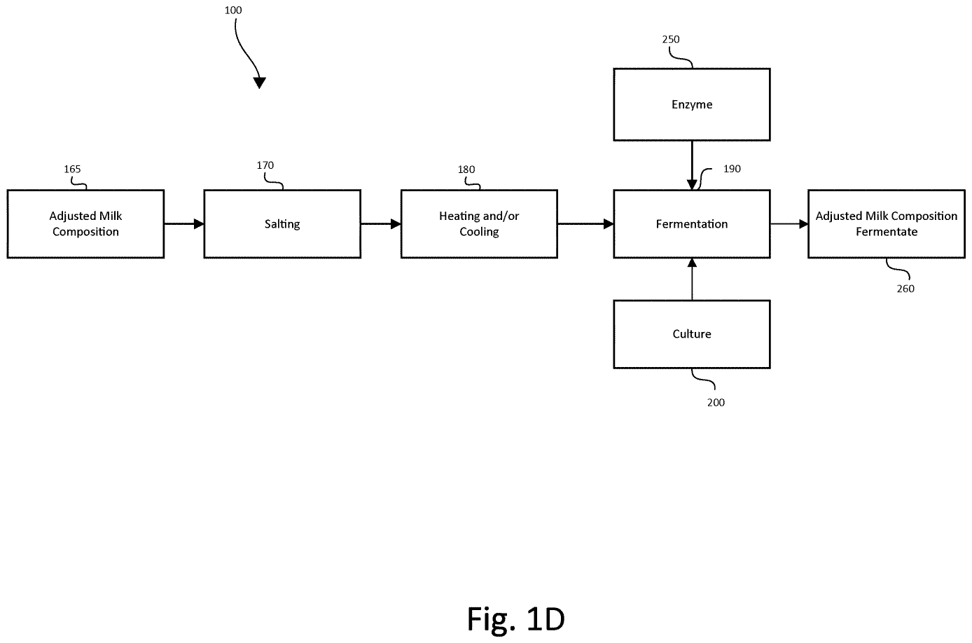

An example of milk composition preparation and adjustment process is provided in FIG. 1A. In the method 100, a starting milk composition 110, such as raw whole milk, is standardized 120 by the addition of one or more standardization components 130, such as cream and/or skim milk, to a targeted fat-to-protein ratio based on the desired final product composition. The standardized milk composition is then pasteurized and cooled 140, such as to about 130 °F. Then composition is then subjected to milk composition adjustment processes 150a, 150b, such as microfiltration and diafiltration, which causes the removal of at least one milk component 160, such as whey protein. The milk composition adjustment processes 150a, 150b lead to production of an adjusted milk composition 165.

In some implementations, following the adjustment of the milk composition by one or more of the disclosed processes, no dairy or milk component or composition (e.g., cream or skim milk) is added to or removed from the adjusted milk composition, other than the removal of moisture, until the finished product has been produced. In some implementations, no dairy or milk component or composition is added to or removed from the adjusted milk composition at least until fermentation and/or enzyme treatment, each as disclosed herein, is complete. Such minimal processing may help retain features of the adjusted milk composition that are desirable for conducting downstream processing steps such as fermentation or enzyme treatment, including the development of desirable products of those processing steps.

Table 1 provides ranges of milk components in an example starting milk composition compared to an example adjusted milk composition produced by microfiltration.

TABLE 1

| | | Desired |
|---|---|---|
| | Expected | wt % Range |
| | wt % Range | Adjusted Milk |
| Milk | Starting Milk | Composition |
| Component | Composition | (microfiltration) |
| Total solids | 12.00-15.00 | 37.00-46.00 |
| Fat | 3.30-5.50 | 20.00-27.00 |
| SNF | 6.50-11.70 | 10.00-26.00 |
| Protein | 2.95-3.75 | 12.00-16.00 |
| Whey | 0.40-0.65 | 0.40-1.95 |
| Casein | 2.40-2.85 | 10.00-15.00 |
| Lactose | 4.10-5.10 | 0.70-1.60 |
| Water | 85.00-88.00 | 54.00-63.00 |

### Benefits of Adjusting Milk Compositions

The milk composition adjustment processes disclosed herein yield improved final products compared to other production methods performed in the absence of the disclosed adjustment processes. In some implementations, the adjustment processes reduce or remove whey proteins, such as by microfiltration of the starting milk composition, and the resulting final products have improved properties compared to products in which whey proteins have not been removed from the intermediate or final products. Improved properties may include one or more of better flavor, better texture, desired consistency, and desired melt characteristics.

For example, use of the disclosed adjusted milk compositions in cheese sauce final products, such as finished pasteurized cheese sauces or heat-treated cheese sauce products for food service operations, may produce cheese sauces with a desirable smooth consistency upon reheating. In contrast, ultrafiltration retains whey proteins from a starting milk composition in an intermediate concentrated product. When such intermediate concentrated product is used in cheese sauce final products, reheating of the cheese sauce products may denature the retained whey proteins. Denaturation may cause an undesirable flocculated or chunky, mashed potato-like consistency in the cheese sauce instead of the desired smooth consistency.

Additionally or alternatively, use of the disclosed adjusted milk compositions in process cheese and process cheese spreads may produce such products with desirable flavors and textures. In contrast, denaturation of the retained whey proteins during a cooking process may result in undesirable flavor and textures and melt restriction. Retained whey proteins may also denature during an evaporation process while producing process cheese and process cheese spreads, which may result in protein agglomeration or aggregation and a concomitant undesirable gritty or chalky texture.

### Fermentation and Optional Bacteriocin Production

With reference to FIGS. 1A and 1B, following one or more milk composition adjustment processes 150a, 150b, the adjusted milk composition 165 may be salted 170, e.g., at about 2.0 to 3.0, or about 2.7 wt % on a dry basis, and may be heat-treated to about 165 °F for 15 seconds with a minimum of 162 °F and/or cooled 180 to about 86 °F for mesophilic lactic acid bacteria or about 110 °F for thermophilic lactic acid bacteria. Salt may help stabilize the adjusted composition during subsequent processing steps, such as fermentation. Heat treatment after salting may help reduce the number of bacteria that may have grown during the milk composition adjustment process, such as when the milk composition adjustment process is conducted at an elevated temperature. Cooling the adjusted composition after heat treatment may help prepare the composition for fermentation, such as by reducing the temperature of the composition such that the residual heat will not damage or kill the cultures for fermentation. In one example, the adjusted composition is a microfiltration concentrate, and it is salted, heat-treated, and cooled prior to fermentation. The salt may help the microfiltration concentrate avoid phase separation during fermentation.

The adjusted composition 165, with or without salting 170, and heat-treating and/or cooling 180, is added to one or more fermenters for fermentation 190 by one or more cultures 200, which may include a lactic acid-producing culture and at least one antimicrobial-producing culture, such as a bacterial culture including but not limited to a nisin-producing culture. After fermentation, a fermentate 260 of the milk composition, e.g., the adjusted milk composition, may be produced, which may include lactic acid alone or in combination with at least one antimicrobial-producing culture.

The fermentation process involves addition of a bacterial culture or cultures capable of converting residual lactose in the adjusted milk composition to lactic acid. The fermentation process may involve fermenting an adjusted milk composition to cause in situ production of lactic acid during a fermentation period of about 4 hours to about 22 hours, such as about 4 to about 14 hours at least about 14 hours, at least about 16 hours, at least about 18 hours, at least about 20 hours, up to about 22 hours, or about 14 to 22 hours, about 16 to 21 hours, or about 18 to 20 hours. Fermentation may result in about 0.25 wt % to about 1.4 wt % lactic acid in a fermentate after at least 4 hours of fermentation, such as about 5 hours to about 20 hours of fermentation, or under pH-controlled fermentation may contain about 0.25 wt % to about 2.3 wt % lactic acid in a fermentate after at least 4 hours of fermentation, such as about 5 hours to about 20 hours of fermentation. In some cases, a pH value of the adjusted milk composition may be allowed to fall without intervention, and for instance, fall to about 4.9 to about 5.4. The fermenting may also be allowed to go to completion. Allowing fermentation to go to completion, which may involve the addition of lactose and/or cultures, may permit a final pH of the fermentate to be predicted with accuracy. This information may be leveraged to yield a more consistent and targeted product makeup and/or pH of a final product.

According to the present disclosure, in some cases at least one antimicrobial-producing culture, e.g., a bacterial culture, is also capable of producing a bacteriocin, such as nisin. Nisin is capable of inhibiting spore germination of pathogenic spore-forming bacteria. Nisin limits non-starter lactic acid bacteria and is most effective against certain gram positive bacteria (e.g., Listeria and Bacillus) and may have more limited activity against gram negative bacteria (e.g., E. coli and Salmonella), yeast and mold. The nisin-producing bacteria may stand alone or a lactic acid-producing bacteria also known as starter cultures, which are cultures composed primarily of lactic acid-producing bacteria. Cultured dairy components may include antimicrobial or antibacterial material and/or antimicrobial or antibacterial producing culture with or without an exopolysaccharide and/or an exopolysaccharide producing culture. Examples of nisin-producing cultures include nisin-producing lactic acid bacteria, such as Lactococcus lactis subsp. cremoris (D 029) and Lactococcus lactis subsp. lactis biovar. diacetylactis and Lactococcus lactis subsp. cremoris, combined with the thermophilic lactic acid bacteria Lactobacillus helveticus (D 227).

Common starter cultures for the production of lactic acid are members of the genera Lactococcus, Lactobacillus, Streptococcus, Enterococcus, and Leuconostoc. Lactococcus are homofermentors and produce solely lactic acid. Bacterial species within the Lactococcus genus include L. lactis (with subspecies lactis, cremoris, hordniae, and tructae), L. garvieae, L. plantarum, L. raffinolactis, L. piscium, L. chungangensis, and L. fujiensis. It is believed that any of the species within the Lactococcus genus may be used in connection with producing the products of the present disclosure. Lactococcus bacteria are commonly used in fermentation applications in the dairy industry and may be used as starter cultures or may be used in combination with other lactic acid-producing bacteria such as Lactobacillus and Streptococcus. In some implementations, L. lactis subsp. lactis and L. lactis subsp. cremoris may be selected due to their ability to safely cause a drop in pH of compositions used to form the products of the present disclosure.

In some implementations, a starter culture may be added alone, or before or after addition of the antimicrobial-producing culture, e.g., the nisin-producing bacteria, such as to control an amount of sugar available for microbial digestion by the starter culture or the nisin-producing bacteria. For example, addition of a starter culture before addition of the nisin-producing bacteria may lower the pH of the adjusted milk composition and may thereby provide an environment in which nisin production can be maximized upon addition of the nisin-producing bacteria. In another example, the pH of the adjusted milk composition may be lowered by the addition of an acid, such as an edible acid, and the nisin-producing bacteria may be added thereto. After a predefined amount of time has passed, or after a predefined amount of nisin has been produced, a starter culture may be added, which may result in more lactic acid being produced than by the nisin-producing bacteria alone.

In addition to providing a preservative effect, the acid-producing bacteria may digest certain carbohydrates and thereby competitively exclude other bacteria, such as pathogens and spoilage-causing organisms, from using the carbohydrates.

Antimicrobial production, e.g., bacterial production such as nisin production, can be pH-dependent and may be controlled by controlling one or more of lactose amount, lactic acid amount, and pH. Production of lactic acid by one or more cultures causes the pH of the fermenting adjusted milk composition to decrease. Accordingly, the rate of antimicrobial production may change over the course of the fermentation process. The total amount of antimicrobial produced may vary based upon the amount of lactose present in the adjusted milk composition. The amount of lactose present in the adjusted milk composition may be controlled by upstream processes, such as the adjustment processes disclosed herein, including diafiltration. The amount of lactose present may be increased by adding lactose before or during the fermentation process. More bacterial cultures may be added during the fermentation process to ferment available lactose. Allowing fermentation to go to completion, which may involve the addition of lactose and/or cultures, may permit an amount of antimicrobial produced and/or a final pH of the fermentate to be predicted with accuracy. This information may be leveraged to yield a more consistent and targeted antimicrobial content and/or pH of a final product.

A desired amount of antimicrobial may be, for example, an amount sufficient to remain active over the shelf life of a final product, which may be about 36 weeks. In one example, a pH drop to 5.4 or lower, such as 4.9, is indicative of the production of a sufficient amount of antimicrobial, e.g., nisin, for a cheese sauce final product to maintain a 36-week shelf life of the product. The amount of nisin present in the final product may be dependent on the dairy composition. In some implementations, compositions containing at least about 7.6 ppm of nisin or other antimicrobial may remain active over the shelf life of the product, which may include cheese sauce. For instance, products having 7.6 ppm nisin or other antimicrobial composed of at least about 60 wt % moisture, at least about 20 wt % fat, about 1.0 wt %, and about 1.9 wt % phosphate solids, with a pH of about 6 and water activity of about 0.972 had a shelf life over a 36-week period.

A desired amount of antimicrobial may be, for example, an amount sufficient to both withstand subsequent processing steps and to remain active over the shelf life of a final product.

In some implementations, the antimicrobial, e.g., nisin, serves as sole or majority antimicrobial agent in the final product. The antimicrobial may replace some or all of a typical antimicrobial, such as sorbic acid, which is regularly used in cheese sauces, such as high moisture pasteurized or heat-treated cheese sauces.

Antimicrobials such as nisin do not affect the flavor of the final product in which it is included. Other known anti-microbials or preservatives, such as sorbic acid, can negatively impact flavor. Nisin-containing products of the present disclose may have improved flavor compared to products that include other anti-microbials or preservatives. Products containing an antimicrobial produced in situ, e.g., nisin, may also have cleaner labels than typical preservative-containing products. For example, the label of a typical preservative-containing product will need to include such preservative as well as cultures used for fermentation; the label of a presently disclosed cheese product in which the antimicrobial has been produced in situ will need to include the cultures used for fermentation, but not a separate preservative.

Additionally or alternatively to in situ antimicrobial production, ex situ-produced antimicrobial may be added to an intermediate or final cheese product. A benefit of adding an antimicrobial component compared to producing in situ is that an antimicrobial-sensitive culture, such as a nisin-sensitive culture, could be used during fermentation. Benefits of producing an antimicrobial such as nisin in situ include, but are not limited to, increased solubility compared to added nisin or other antimicrobial, greater effectiveness as an antimicrobial when well-solubilized compared to added nisin or other antimicrobial; and use of reduced amounts of nisin or other antimicrobial from in situ production compared to added ex situ-produced nisin or other antimicrobial. Products produced with in situ-produced nisin or other antimicrobial may also have cleaner product labels than products to which nisin has been added. In some implementations, products may be produced without added ex situ-produced nisin or other antimicrobial.

### Antimicrobial Production Following Milk Composition Adjustment

The antimicrobial production disclosed herein may follow the milk composition adjustment process disclosed herein. If an antimicrobial-containing composition, such as a fermentate, is subjected to a separation step, such as a whey protein removal step, about 75 to 90% of the antimicrobial, e.g., nisin, can be lost during the separation step. In the presently disclosed methods, subjecting milk compositions to adjustment processes prior to, but not after, fermentation may help avoid loss of the antimicrobial and maintain the amount of antimicrobial present in the fermentate as the fermentate is further processed. The amount of nisin or antimicrobials needed to preserve products produced by the presently disclosed method may be less than the amount of nisin or other antimicrobial needed for products produced by methods with post-initiated fermentation separation/removal steps, such as whey separation/removal or separation/removal of other milk components.

pH-Controlled Fermentation

In methods of fermenting lactose, the pH of the fermenting material may be allowed to drop naturally as the amount of lactose decreases and the amount of lactic acid increases over time. For example, the pH of fermenting milk compositions may drop to about 5.4 or lower, such as 4.9, in the natural course of converting lactose to lactic acid. In the presently disclosed methods, the pH may be controlled during the fermentation process to maximize lactic acid production, maximize the antimicrobial, e.g., nisin, production, optimize enzyme activity, reduce the need for emulsifying salts, and/or avoid casein precipitation. For example, the pH may not be allowed to decrease as low as it would without intervention.

The pH of the fermenting material may be controlled by addition of a pH adjuster, which may raise or lower the pH and may be an acid or a base. The type, concentration, and volume of the pH adjuster may be selected based on or more of the pH of the fermenting material, the desired pH of the fermenting material or the material following fermentation, the lactose content of the fermenting material, the desired amount of lactic acid produced, and the desired amount of antimicrobial, e.g., nisin, produced. In one example, the pH adjuster is sodium hydroxide, such as 5 wt % to 10 wt % sodium hydroxide or potassium hydroxide. In another example, the pH adjuster is an edible acid, such as citric acid.

The pH adjuster may be added during fermentation. With reference to FIG. 1C, a portion of the fermenting adjusted milk composition is withdrawn 210 from a fermentation tank. A pH adjuster 220 is introduced to an in-line recirculation loop, such as by a peristaltic pump. The removed fermenting material and the pH adjuster 220 are promptly sheared 230, such as by a shear pump, to rapidly disperse the pH adjuster 220 in the fermenting material. Rapid dispersion helps to prevent protein flocculation and/or a rough, inhomogeneous appearance in the fermentation tank. The sheared material is then returned 240, e.g., piped back, to the fermentation tank. The withdrawal and return of fermenting material may be performed periodically or continuously during the fermentation process. The neutralized material returned to the fermentation tank helps to maintain the pH at a desired level.

In some implementations, lactic acid production is optimized in the production of the lactic-acid producing fermentate 260 by employing pH-controlled fermentation. Optimizing lactic acid production during fermentation may help avoid or reduce the addition of lactic acid to a downstream or final product. The reduction or omission of lactic acid provides benefits, such as a cleaner product or product label that does not include lactic acid. As another example, production costs may be less when pH-controlled fermentation is employed because lactose is typically a lower-cost component than lactic acid, and the potential addition of lactose to maximize in situ lactic acid production may be less expensive than adding ex situ-produced lactic acid. The pH of the fermenting material may be neutralized at or about pH 5.8, such as about 5.7 to about 5.9. Lactic acid production may be greater at a pH of about 5.8 than at a lower pH, such as 5.4 (see Example 1). Without being limited to any mechanism or mode of action, the increasing levels of lactic acid as fermentation naturally progresses may have a negative effect on cell growth. Neutralizing the pH at about 5.8 may permit more cell growth and replication than at a lower pH, and the higher cell counts may then convert more lactose to lactic acid.

In some implementations, an antimicrobial, e.g., nisin, production in the fermentate 260 is optimized by employing pH-controlled fermentation. The pH of the fermenting material may be neutralized at or about pH 5.8. Antimicrobial, e.g., nisin, production may be greater at a pH of 5.8 than at a lower pH, such as 5.4 (see Examples 2 and 3). Without being limited to any mechanism or mode of action, the increasing levels of lactic acid as fermentation naturally progresses may have a negative effect on cell growth. Neutralizing the pH at about 5.8 may permit more cell growth and replication than at a lower pH, and the higher cell counts may then produce more antimicrobial such as nisin.

In some implementations, enzyme activity is optimized by employing pH-controlled fermentation. The activity of a given enzyme is maximized at its optimum pH; as the pH increases above or decreases below the optimum value, enzyme activity decreases. Controlling the fermentation process such that the pH is at or near an enzyme's optimum pH may allow the enzyme to operate at a higher activity level, either concurrently with or subsequent to fermentation, than if the pH was not controlled. Enzymes may include proteases, lipases, hydrolases such as lactase, or specific phospholipases or glutaminases, all as described herein.

In some implementations, pH-controlled fermentation allows for the reduction or omission of emulsifying salts in final products. Emulsifying salts may include phosphate, tartrate, or citrate salts of sodium or potassium. Examples of emulsifying salts include sodium citrate, sodium phosphate and/or trisodium phosphate. In some dairy product production methods, emulsifying salts may be added to adjust the pH of an intermediate or final product to a target pH. For example, in some lactose fermentation processes, described herein, the pH of the fermenting material naturally drops to about 5.4 or lower. In the production of process cheese, process cheese sauces, cheese spreads, and other similar products, the target pH may be about 5.8. Emulsifying salts are added in part to increase the pH of the fermented material from about 5.4 or lower to a target pH of about 5.8.

In the presently disclosed methods, the pH of the fermentation process is controlled, such as to maintain the pH at about 5.8, and emulsifying salts are not added or are added a lower amount than in the absence of pH-controlled fermentation. Without being limited to any mechanism or mode of action, maintaining a pH of about 5.8 during fermentation could keep milk proteins in a similar pH-dependent charged state as that typically driven by added emulsifying salts, thus reducing or obviating the need for emulsifying salts. The reduction or omission of emulsifying salts provides benefits, such as a cleaner product or product label that does not include emulsifying salts. As another example, sour flavors are more likely to develop, or be more pronounced, when the pH of the fermentation falls to about 5.4 than if it is maintained at about 5.8.

In some implementations, dairy derived emulsifying salts may be included to reduce or omit addition of emulsifying salts in final products. For instance, dairy derived emulsifying salts may be derived from an ultrafiltration permeate of the disclosed milk compositions or other dairy streams. The ultrafiltration permeate may be subjected to further processing such as the removal of monovalent ions, e.g., through nanofiltration, and subjecting the depleted ion stream to ion exchange, such as a sodium containing ion exchange column with sodium containing eluting solution, to produce sodium phosphate and sodium citrate. Such dairy derived emulsifying salts may also have calcium removed using ion exchange, e.g., an ion exchange column. Systems and methods for producing dairy derived emulsifying salts from a dairy stream are disclosed in co-owned U.S. Pat. No. 11,337,435, which is incorporated herein by reference for any useful purpose. Dairy derived emulsifying salts may act similarly upon the casein by allowing the exposure of hydrophobic and hydrophilic sites to facilitate emulsification. In some implementations, where the milk compositions are subjected to microfiltration, the microfiltration permeate may be further subjected to the aforementioned processes for isolating dairy derived emulsifying salts. When captured from a permeate of the initial milk composition stream, the use of such native emulsifying salts may provide a cleaner label. The ability to further separate, precipitate and concentrate down dairy derived emulsifying salts within a separate stream of the processes of the present disclosure could allow for addition back at various stages of production, such as at a cooker in the manufacture of process cheese, spread, or sauces.

In some implementations, pH-controlled fermentation is implemented to maintain the pH of the fermenting material above the isoelectric point of casein, which is about 4.6 to about 4.8. A drop in pH level towards 4.8 may result in phase separation, coagulation, excessive thickening of the fermentate, and/or release of calcium from micelles. Such negative effects can be avoided by the utilization of pH-controlled fermentation as disclosed herein.

Antimicrobial Production and pH-Controlled Fermentation

The antimicrobial production disclosed herein may be combined with the pH-controlled fermentation disclosed herein. By combining the processes, such as by maintaining the pH of an antimicrobial-producing culture at about 5.4 to about 5.9, the amount of antimicrobial produced can be maximized. The higher level of antimicrobial in a fermentate may provide a higher level of antimicrobial activity in a final product, and thus more antimicrobial may be produced than in the absence of maintaining the pH range at 5.4 to about 5.9 or about 5.5 to about 5.9. For instance, maintaining the pH of a nisin-producing culture at about 5.4 to about 5.9, about 5.5 to about 5.9 or about 5.8, the amount of nisin produced can be maximized to thereby provide a higher level of antimicrobial activity.

A pH of about 5.8 is a typical pH for process cheese products. As disclosed herein, emulsifying salts may be omitted or their amounts reduced in a final product when pH-controlled fermentation produces a fermentate already at a pH of about 5.8. The potential loss of a marginal bacteriostatic effect typically provided by emulsifying salts may be offset by the higher level of nisin generated when pH-controlled formation is employed.

Nisin-containing products produced with pH-controlled fermentation may contain about 4 ppm to about 35 ppm nisin after at least 4 hours of fermentation, such as about 5 hours to about 12 hours of fermentation. (See Example 2.) By comparison, nisin-containing products produced without pH-controlled fermentation may include about 4 ppm to about 23 ppm nisin after at least 4 hours of fermentation, such as about 5 hours to about 12 hours of fermentation. (See Example 2.) In other examples, depending on the type of nisin-producing culture added, these levels of nisin may be produced after about 14 to about 22 hours of fermentation with or without pH-controlled fermentation.

Nisin-containing products produced with pH-controlled fermentation may contain about 0.25 wt % to about 2.3 wt % lactic acid after at least 4 hours of fermentation, such as about 5 hours to about 14 hours of fermentation. (See Example 1.) By comparison, nisin-containing products produced without pH-controlled fermentation may include about 0.25 wt % to about 1.4 wt % lactic acid after at least 4 hours of fermentation, such as about 5 hours to about 14 hours of fermentation. (See Example 1.). In other examples, depending on the type of nisin-producing culture added, these levels of lactic acid may be produced after about 14 to about 22 hours of fermentation with or without pH-controlled fermentation.

### Enzyme Treatment

The processes disclosed herein may include enzyme treatment during or after fermentation. In one example, and with reference to FIG. 1D, one or more enzymes 250 are added during fermentation 190 to produce the fermentate 260. Enzyme treatment may produce desirable and tunable product characteristics such as specific flavors or prolonged product stability. Examples of enzymes that may be added to fermenting or fermented material include proteases, hydrolases such as lactase, lipases such as phospholipases, and deaminases such as glutaminase, protein glutaminase, glutamate dehydrogenase, and monoamine oxidase.

In some implementations, a phospholipase, such as phospholipase A, is added to cleave all or a portion of phospholipids from fat globule membranes present in the fermenting or fermented adjusted milk compositions. Without being limited to any mechanism or mode of action, cleavage of phospholipids may increase the ability of the fat globules to interact with milk proteins more effectively. The improved interaction may improve the performance of final products, such as process cheese sauces, including when such products are used in hot hold applications. For example, the improved interaction between fat globules and milk proteins may increase fat stability due to a decreased opportunity for fat to coalescence and separate from the sauce in heated applications. As another example, the improved interaction may increase protein stability by decreasing opportunities for hydrophobic interactions between proteins that would cause them to curdle or clump together or otherwise create an inhomogeneous mass of protein, serum/water, and fat phases in the product. Additionally or alternatively, cleaved lyso-phospholipids may act as emulsifying agents to help stabilize fat and protein interactions.

In some implementations, a protein glutaminase is added to convert glutamine residues to glutamic acid. In the absence of protein glutaminase treatment, glutamine residues are neutrally charged. Protein glutaminase treatment increases the number of glutamic acid residues, which have an ionizable functional group that provides a pH-dependent negative charge. At a pH of about 5.8, which is a typical pH value for a process cheese product, the increase in negatively charged residues may promote instability in dairy proteins. Without being limited to any mechanism or mode of action, the instability may cause proteins to open up and thereby increase the availability, through increased exposure, of amino acid residues to interact with fats. The more open conformation may also increase the availability of amino acid residues to interact with water, as the protein will hold more water due to the increase in negatively charge sites compared to no protein glutaminase treatment. Increased protein hydration may delay protein aggregation and/or separation when final products are held at elevated temperatures, a condition under which hydrophobic intra- and inter-protein interactions are more likely to occur than at room or refrigerated temperatures. For instance, protein glutaminase may facilitate the interaction of protein-bound amino acids and fats in the adjusted milk composition to help stabilize the dairy product.

In some implementations, enzyme treatment allows for the reduction or omission of emulsifying salts in final products. As disclosed herein, emulsifying salts may include phosphate salts such as sodium phosphate. In some dairy product production methods, emulsifying salts may be added to stabilize fats and proteins and thereby prevent protein coagulation, prevent fat and oil separation, maintain a desired consistency and texture, and/or prolong shelf life.

In the presently disclosed method, adding product stability-enhancing enzymes, such as phospholipases or glutaminases, may reduce or eliminate the need for emulsifying salts. The increased fat and protein stability provided by enzyme treatment may substitute for the stabilizing functions traditionally provided by emulsifying salts.

As a further example, an exopolysaccharide producing culture may be added to produce added add firmness and viscosity to finished product sauce, and/or to produce a clean label finished product.

### Enzyme Treatment Following Milk Composition Adjustment

The enzyme treatment disclosed herein may follow the milk composition adjustment process disclosed herein. If an enzyme-treated composition, such as an actively fermenting or previously fermented dairy composition, is subjected to a separation step, such as a whey protein or other milk component removal step, at least some of the enzymes and/or reaction products are lost during the separation step. In the presently disclosed methods, subjecting milk compositions to whey protein removal prior to, but not after, enzyme treatment may help avoid loss of enzymes and/or reaction products and maintain the amount of enzymes and/or reaction products present in the fermentate as the fermentate is further processed. Upon production of the fermentate, the fermentate may be heated to cease enzyme activity.

In some dairy product production methods, up to about 90% of the enzyme added to a typical cheese vat may be lost in a subsequent whey separation step. The amount of enzyme needed to accomplish a desired reaction in the presently disclosed methods may be less than the amount of enzyme needed in methods with concomitant fermentation whey separation/removal steps. In some enzymatic reactions, the rate of enzyme-catalyzed reactions may increase with an increase in the enzyme concentration. The rate of enzyme-catalyzed reactions, and the concomitant production of reaction products, may be faster in the presently disclosed methods than in methods with concomitant fermentation whey separation/removal steps.

Adjustment Processes, Antimicrobial Production, pH-Controlled Fermentation, and Enzyme Treatment

The milk composition adjustment processes, antimicrobial production, pH-controlled fermentation, and enzyme treatment processes disclosed herein may be practiced separately or in combination. A combined method demonstrates the benefits, as described herein, of each process individually, including maximizing antimicrobial production, maintaining antimicrobial and/or enzyme reaction products, and producing final products that are resistant to separation and/or flocculation when heated.

Additional benefits relate to the ability to reduce or omit components that are typically added to dairy products such as process cheese, cheese spreads, and/or cheese sauces. For example, the combination of the methods disclosed herein enables the omission of one or more the following: an added preservative, such as sorbic acid, because an antimicrobial is produced in situ; emulsifying salts because a target, e.g. higher, pH is maintained during fermentation; added lactic acid because its production is optimized during fermentation; and added flavor ingredients because enzyme treatment can produce desired flavors, and sour flavors that develop at a lower pH do not need to be masked when the pH is kept higher during fermentation.

Accordingly, products produced by the combined methods may be free of one or more of a preservative (e.g., added preservatives), emulsifying salts, lactic acid (e.g., added lactic acid), and flavor-producing compounds (e.g., added flavor-producing compounds). Such products may be considered clean or cleaner than products produced by typical methods. A product label for final products produced by the methods disclosed herein may include only milk, salt, cheese cultures, and enzymes. In some examples, a label may also include natural flavor or other added flavors. The milk may be listed as pasteurized milk.

### Split-Fed Batch Processing

Any one or more of the milk composition adjustment processes, fermentation, antimicrobial production, pH-controlled fermentation, and enzyme treatment processes disclosed herein may be processed as a single dairy stream or a split stream. The dairy stream could be split into two or more batches that are separately processed and then recombined. A split stream is also referred to herein as a split-fed batch, dual fill or series fill. Splitting the dairy stream may improve flexibility and control of various product components and production steps. Splitting the dairy stream allows for the utilization of different adjustment process, fermentation cultures and conditions, antimicrobial-producing or-sensitive cultures, pH conditions, and enzyme types within a single continuous or semi-continuous production process.

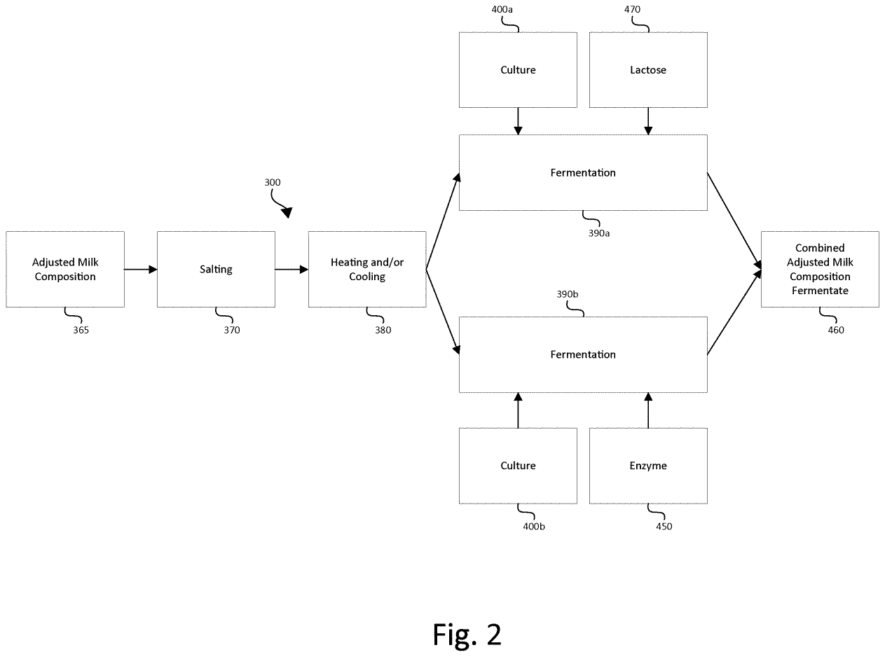

An example of split-fed batch processing is provided in FIG. 2. In the method 300, features 365-460 are as described for the similarly numbered elements of FIGS. 1B and 1C (i.e., features 165-260). Elements 110-160 of FIG. 1A, which lead to production of the adjusted milk composition 165 of the method 100 of FIGS. 1A-1D, may be used to produce an adjusted milk composition 365 of the instant method 300. The dairy stream of the present disclosure may be split at any time, and may be split more than once. In the example shown in FIG. 2, an adjusted milk composition 365, which may be salted 370, and may be heat-treated and/or cooled 380, is split into two fermentation tanks for fermentation 390a, 390b. Different cultures, enzymes, and/or dairy components may be added to each tank as described below. After fermentation or fermentation and enzyme treatment, the split processed fermentates are recombined to produce a combined adjusted milk composition fermentate 460.

In some implementations, milk composition adjustment processes as disclosed herein are subject to split-fed batch processing. In some adjustment processes, such as microfiltration, more whey protein may be retained within the adjusted milk composition (microfiltration concentrate) over time, which may be a result of filtration membrane fouling over time. In some implementations, the milk composition stream may be split into multiple batches to decrease the demand on a given filtration membrane.

In some implementations, fermentation as disclosed herein is subject to split-fed batch processing. An adjusted milk composition may be split into at least two fermentation tanks and different starter cultures may be added to each tank. The different cultures may result in the production of different flavor compounds such that final products produced from the combination of fermentates have a flavor derived from the combination of cultures instead of a single culture. Additionally or alternatively, the each tank may have different reaction conditions, such as temperature and/or pH.

Although pH-controlled fermentation is not depicted in FIG. 2, the withdrawal 210, pH adjuster 220, shearing 230, and return 240 elements described above for method 100 (see also FIG. 1C) could similarly be employed in the instant method 300.

As another example, and with reference again to FIG. 2, an adjusted milk composition 365 is split into two fermentation tanks 390a, 390b. Lactose is added 470 to one tank but not the other. The fermentates are recombined to produce a combined adjusted milk composition fermentate 460. Fermenting two tanks having different amounts of lactose allows for flexibility and control of lactose content and thereby the amount of lactic acid produced in and/or the pH of the fermentate.

In some implementations, fermentation, including antimicrobial production as disclosed herein, is subject to split-fed batch processing. With reference to FIG. 2, an adjusted milk composition is split into two fermentation tanks 390a, 390b. A culture 400a, which may be an antimicrobial-producing culture, is added to a first tank but not a second tank. A second culture 400b, which may be an antimicrobial-sensitive culture, is added to a second tank but not the first tank. The fermentates are recombined to produce a combined adjusted milk composition fermentate 460. The different cultures may result in the production of different flavor compounds such that final products produced from the combination of fermentates have a flavor derived from the combination of cultures instead of a single culture.

In some implementations, enzyme treatment as disclosed herein is subject to split-fed batch processing. A milk composition may be subjected to split-fed batch enzyme treatment concurrent with fermentation, as shown in FIG. 2, or prior to or subsequent to fermentation. In the example shown in FIG. 2, an adjusted milk composition stream is split into two fermentation tanks 390a, 390b. At least one enzyme 450 is added to one tank. A different enzyme or enzymes may be added to a separate tank (not shown). Reaction conditions, such as temperature and pH, in each tank may be tailored to the enzyme(s) in that tank. The fermentates are recombined after fermentation and enzyme treatment to produce a combined adjusted milk composition fermentate 460. Splitting the stream allows for control of the amount of protein, fat, or carbohydrate substrate on which the enzymes act. Enzymes may become inactive when their substrate has been consumed, or they may be deactivated, such as by heating or a downstream cooking step. Split-fed batch enzyme treatment enables control of whey protein amount in intermediate and final products, differential production of enzyme reaction products, and flexibility and control of flavor development, each as disclosed below.

As described above, during microfiltration, proportionally more whey protein may be retained within the adjusted milk composition (microfiltration concentrate) over time. In some examples, the microfiltration concentrate stream may be split into multiple batches, either throughout the course of the adjustment process or towards the end of the adjustment process, when whey protein concentrations in the adjusted milk composition have increased compared to the start of the adjustment process. Each split batch may be subjected to differential enzyme treatment to decrease the amount of whey protein in at least one of the batches. Suitable enzymes for such enzyme treatment include proteases. Such treatment could improve final products produced from the microfiltration concentrate by decreasing the amount of whey protein and thereby decreasing potential negative effects of the inclusion of whey protein in hot applications, such as protein flocculation.

As another example, in some methods of producing process cheese, natural cheese in certain age categories or classifications is typically used. The categories generally reflect differences in the quantity and nature of intact proteins present in the cheese, which can impact characteristics such as texture, viscosity, and flavor attributes in finished products produced from the natural cheese. In some implementations, an adjusted milk composition is split into multiple batches and subjected to variable enzyme treatment between the batches to generate enzyme reaction products and/or treated milk compositions that replicate or mimic the features of the age classifications. Suitable enzymes for generating such modifications include proteases and lipases.

As another example, different enzymes may be added to different batches to produce different flavor compounds. Suitable enzymes include proteases, lipases, and hydrolases such as lactase. Splitting and recombining the batches allows for flexibility, control, and customization of flavor compound development and the flavor of final products produced from the combination of differently treated batches.

As a further example, an exopolysaccharide producing culture may be added to different tanks or batches to produce added add firmness and viscosity to finished product sauce, and/or to produce a clean label finished product.

Products Produced from the Disclosed Methods

The presently disclosed methods may be used to produce products, either intermediate or final, that form part of all of dairy products, such as process cheese, cheese spreads, and cheese sauces. The products may be or include antimicrobial-containing (e.g., nisin-containing) compositions, and such compositions may have been produced with or without the disclosed milk composition adjustment processes, pH-controlled fermentation, and enzyme treatment. The products may be or include enzyme-treated compositions, and such compositions may have been produced with or without the disclosed milk composition adjustment processes, antimicrobial production, and pH-controlled fermentation. The products may be or include compositions produced from pH-controlled fermentation, and such compositions may have been produced with or without the disclosed milk composition adjustment processes, antimicrobial production, and enzyme treatment. Natural cheese may be added to the antimicrobial-containing products of the present disclosure.

The antimicrobial-containing products of the present disclosure may be intermediate products used in further processing steps for the production of cheese products. Prior to such processing, the antimicrobial-containing products may be free of emulsifying salts and other additives as disclosed herein. In some implementations the antimicrobial-containing products may be the primary or sole dairy source used in the production of dairy products. Additionally, the antimicrobial-containing products may not be subjected to further removal or separation steps such as those described herein (e.g., microfiltration, ultrafiltration). For example, the antimicrobial-containing products may not be subjected to whey separation steps that are used in conventional cheese production processes. Accordingly, some cheese products of the present disclosure may be formed solely of the antimicrobial-containing products, while other cheese products may retain the same amount of whey as in the antimicrobial-containing products and include added components as provided herein.

Products made from the antimicrobial-containing products disclosed herein may include an amount of antimicrobial sufficient to maintain the usability, fitness for consumption, and/or saleability of the product during its shelf life. Regulations set a maximum of 250 ppm nisin in pasteurized process cheese spread. However, the amount of nisin may be less than the maximum amount set by regulatory agencies. For instance, about 4.5 ppm nisin or this or other amounts of an antimicrobial may be used for some products and maintain a shelf life of up to 36 weeks. Other levels of nisin and/or other antimicrobial may also be effective and may range from about 1 to 10 ppm, about 2 to 8 ppm, or about 3 to 6 ppm, or about 3, 4, 5, 6, 7, 8, 9, 10 ppm or any range between any of the listed numbers.

In various embodiments, the antimicrobial-containing products or final products of the present disclosure may be free of, for example, added (ex-situ produced) natural cheese, added process cheese, added lactic acid, added antimicrobial (e.g., nisin), added preservatives, added flavor compounds, emulsifying salts (e.g., phosphate, tartrate, or citrate salts of sodium or potassium), sorbic acid, one or more monoglycerides and/or diglycerides, ethylenediamine, one or more porphyrins (e.g., porphine), ethylenediaminetetraacetic acid (EDTA), xanthan gum, guar gum, additional gums, and/or starch. The absence of one or more of such components may enable the products of the present disclosure to be considered as clean label or cleaner label. In some examples, the products may be identified as clean label due to the absence of phosphates or phosphate-based components alone. Additionally or alternatively, the clean label identity of the products may be due to the absence of a phosphate-based chelator typically incorporated into dairy products to open casein micelles.

In some implementations, the antimicrobial-containing products or final products of the present disclosure may include a selective enzyme such as a phospholipase, and in such cases the presence of phospholipase may facilitate providing stability to the final product, such as when a cheese sauce is used in hot food service applications where cheese sauces or other cheese products are held hot for extended periods of time prior to consumption. In addition, such cheese sauces or other cheese products may be produced without the use of emulsifying salts, for example because the phospholipase-treated fats may interact more effectively with protein to produce a more stable sauce that resists oiling off during hot holding, including of cheese sauces.

Additionally or alternatively, the antimicrobial-containing products or final products of the present disclosure may include a selective enzyme such as a protein glutaminase, which may be useful in hot food service applications where cheese sauces or other cheese products are held hot for extended periods of time prior to consumption. The addition of protein glutaminase may add stability during the hot hold of foodservice cheese sauces or other cheese products because of increased interaction with fat and increased hydration, which may delay protein aggregation and/or separation when cheese sauces are held at elevated temperatures. In this example, such cheese sauces or other cheese products may be produced without sodium phosphate emulsifying salts.

Potassium sorbate or sorbic acid may be included in the antimicrobial-containing or post-fermentate compositions used to form the products of the present disclosure to prevent the growth of mold, yeast, spoilage organisms and pathogens. Potassium sorbate is generally active at a pH of 6.0 or below, and accordingly in some implementations, potassium sorbate may be activated in the composition by a drop in pH upon the production of acid by the acid-producing bacteria or upon addition of acid. Potassium sorbate or sorbic acid may be added at about 0.05 to 0.5 wt %, such as about 0.1, 0.15, 0.2, 0.25, 0.3, or 0.4 wt % of the final product, or of the antimicrobial-containing or post-fermentate compositions when such compositions are precursors to a final product.

### Cheese Sauce Products

Cheese sauce products may be formed of, or contain, the nisin-containing products of the present disclosure. For example, the antimicrobial-containing products may account for about 25 to about 100 wt % of the cheese sauce product. The amount of nisin-containing products may vary, and may depend on factors such as the specifically desired flavor and/or nutritional value of a particular cheese sauce product. In some examples, the antimicrobial-containing product content of the cheese sauce products accounts for substantially all of the cheese sauce product, or may range from about 25 wt % to about 90 wt %, 30 wt % to about 90 wt %, about 50 wt % to about 90 wt %, about 60 wt % to about 90 wt %, about 80 wt % to about 90 wt %, about 85 wt % to about 95 wt %, about 90 wt %, about 95 wt %, about 98 wt %, about 25 wt % to about 60 wt %, about 30 wt % to about 60 wt %, about 25 wt % to about 45 wt %, about 25 wt % to about 35 wt %, about 35 wt % to about 55 wt %, about 40 wt % to about 50 wt %, about 42 wt % to about 48 wt %, or about 43 wt % to about 45 wt % of the cheese sauce product.

In some implementations, the cheese sauce product may be formed of the antimicrobial-containing products of the present disclosure and may be free of emulsifying salts. Other components of the cheese sauce product may include, but are not limited to, added cheese (natural or process), salt, lactic acid, sorbic acid, concentrated milk fat (CMF), buttermilk powder, cultured pasteurized milk, skim milk, whole milk, whey, sweet whey, or their dried equivalents, milk minerals, sugar, and/or water. The product components may additionally include vegetables or vegetable components, meats and/or meat flavoring, and/or flavor additives as necessary to achieve a desired cheese sauce variety, chelators and/or hydrocolloids. In embodiments, where added cheese is included as a product component, the cheese may comprise a blend of two, three, four or more cheese varieties, one or more of which may be natural or processed. Example cheese varieties include, but are not limited to, cheddar, Gouda, Swiss, pepper jack, mozzarella, Muenster, cotija, and/or Monterey jack. Product components may also include plant-based components such as canola, sunflower, and/or soy products, which may be provided in the form of various extracts, powders and/or oils. Other components may include natural flavors and emulsifying salts.

The cheese sauce products may be non-solid at room temperature. The non-solid physical state of the cheese composition may be defined by a viscosity greater than that of a liquid, but less than a solid. For example, the cheese sauce products may have a creamy texture at room temperature, e.g., about 68 °F (20 °C) to about 77 °F (25 °C), with a viscosity ranging from about 50 cPs (centipoises) to about 50,000 cPs at room temperature, e.g., ambient temperature. The non-solid state of the cheese sauce products may be further characterized by the composition being smooth and flowable at room temperature, such that the composition can be readily poured from a container.

A moisture level of the cheese sauce products may range from about 55 wt % to about 65 wt %, about 45 wt % to about 70 wt %, about 50 wt % to about 70 wt %, about 50 wt % to about 60 wt %, about 60 wt % to about 70 wt %, or about 50, 52, 55, 58, 60, 52, 65, 67, or 70 wt % of the cheese sauce product. In some implementations, the moisture may be derived solely from the antimicrobial-containing products, or some moisture may be added moisture (e.g., in the form of a liquid such as water, or a dairy component such as milk or cream). Moisture levels may impact product viscosity, such that the greater the moisture level, the less viscous, and vice-versa.

Salt may be included in the cheese sauce product and the amount may depend on the desired taste and/or nutritional content of the product. For example, low-sodium varieties of the cheese sauce products disclosed herein may include less salt than other varieties. In various embodiments, the salt content of the cheese sauce product may range from about 0.5 wt % to about 3 wt %, about 0.5 wt % to about 2 wt %, or about 0.5 wt % to about 1.5 wt %, about 1.0 to about 3.0 wt %, or about 2.0 to about 3.0 wt %.

Production of cheese sauce products may use the antimicrobial-containing products alone (e.g., in slurry form) or may combine one or more of the antimicrobial-containing products of the present disclosure with one or more product components of the cheese sauce described herein. In one example, the cheese sauce product is a heat-treated cheese sauce product. In addition or alternatively, the cheese sauce product may be free of added emulsifying salts. In embodiments, one or more of the antimicrobial-containing products alone or in combination with various cheese sauce components may be fed to an evaporator vessel where moisture in the composition is evaporated to form a concentrated composition with a reduced moisture content.

In some implementations, the evaporator vessel may be configured as a vacuum chamber and may be operated under vacuum pressure, for instance, below standard atmospheric pressure, from about 16 inHg to about 29.5 inHg (which corresponds to about 176 °F to 53 °F boiling point of water), or from about 20 inHg to about 28 inHg, or from about 24 inHg to about 29.5 inHg, or about 28 inHg. In the evaporator vessel, the composition may be continuously transferred by blades, such as by a mutator/wiper shaft of a wiped film evaporator or a scraped surface heat exchanger, to form a thin film while maintaining the composition at the evaporation temperatures via heat transfer walls.

Additionally or alternatively, one or more of the antimicrobial-containing products alone or in combination with various cheese sauce components may be added to a cooker, optionally along with emulsifying salts, and steam may be injected into the cooker, e.g., a kettle-type cooker.

In another example, the components may be heated in one or more initial cooking steps at a temperature below 180 °F, or a range of about 145 °F (63 °C) to about 180 °F (82 °C). The duration of each cooking step may be about 1.5 minutes to about 9 minutes, about 1.5 minutes to about 4.5 minutes, about 2 minutes to about 4 minutes, or about 3 minutes. Where more than one cooking step is performed, the cheese sauce components may be allowed to cool between steps to temperatures below about 158 °F (70 °C) but at or above room temperature. After the one or more initial cooking steps, an additional cooking step may be implemented at the same or an increased temperature relative to the initial cooking step(s). In some embodiments, the additional cooking step may have a duration of about 3 minutes, although the duration may range from 1, 2, 3, 4, 5, or more minutes, and the cooking temperature may be below 212 °F, or a range of about 145 °F (63 °C) to about 180 °F (82 °C).

The finished cheese sauce product may be sealed or packaged and stored at refrigeration temperatures, e.g., about 39 °F (4 °C). In implementations where the finished cheese sauce product is not heated to temperatures required for pasteurization and/or not held at the temperature for the pasteurization time, the product may be characterized as a heat-treated cheese sauce product.

Cheese sauce products or the portions of cheese sauce products containing the antimicrobial-containing products produced without pH-controlled fermentation, as disclosed herein, may include about 7 ppm to about 18 ppm nisin, 10 ppm to about 16 ppm nisin, about 11 ppm to about 15 ppm nisin, or about 12 ppm to about 15 ppm nisin and/or another antimicrobial. (See Example 3.) Cheese sauce products or the portions of the cheese sauce products containing the nisin-containing products produced with pH-controlled fermentation, as disclosed herein, may include about 21 ppm to about 30 ppm nisin, about 22 ppm to about 29 ppm nisin, or about 23 ppm to about 28 ppm nisin and/or another antimicrobial. (See Example 3.) For instance, where the cheese sauce product contains the nisin-containing products of the present disclosure at 100%, the product may include the aforementioned ranges of nisin, while a cheese sauce product containing 25% nisin-containing products of the present disclosure may include 25% of the aforementioned ranges of nisin.

### Process Cheese and Process Cheese Spreads

Process cheese (e.g., process cheese loaf) or process cheese spread products may be formed of, or contain, the antimicrobial-containing products of the present disclosure. For example, the antimicrobial-containing products may account for about 25 to about 94 wt % of such products. The amount of antimicrobial-containing products may vary, and may depend on factors such as the specifically desired flavor and/or nutritional value of a particular process cheese or process cheese spread product. In some examples, the antimicrobial-containing product content of such products account for substantially all of the product, or may range from about 25 wt % to about 90 wt %, 30 wt % to about 90 wt %, about 50 wt % to about 90 wt %, about 60 wt % to about 90 wt %, about 80 wt % to about 90 wt %, about 85 wt % to about 94 wt %, about 90 wt %, about 94 wt %, about 94 wt %, 25 wt % to about 60 wt %, about 30 wt % to about 60 wt %, about 25 wt % to about 45 wt %, about 25 wt % to about 35 wt %, about 35 wt % to about 55 wt %, about 40 wt % to about 50 wt %, about 42 wt % to about 48 wt %, or about 43 wt % to about 45 wt % of the product.

Other components of the process cheese or process cheese spread products may include the product components described above in connection with cheese sauce products.

The process cheese products may be solid at room temperature, while process cheese spread products may be non-solid at refrigeration and room temperatures and may be spreadable at these temperatures. For example, the non-solid physical state of the process cheese spread composition may be defined by a viscosity greater than that of a liquid, but less than a solid. For example, the cheese spread products may have a thick consistency at room temperature, e.g., about 68 °F (20 °C) to about 77 °F (25 °C), with a viscosity ranging from about 100,000 cPs to about 160,000 cPs, depending on the exact temperature. The non-solid state of the process cheese spread products may be further characterized by the composition being spreadable at refrigeration temperatures, and at room temperature the composition cannot be readily poured from a container.

A moisture level of the process cheese products, e.g., process cheese loaf products, may range from about 35 wt % to about 45 wt %, such as about 36 wt % to about 45 wt %, about 40 wt % to about 45 wt %, about 42 wt % to about 45 wt %. For example, block process cheese may have a moisture range of about 35 wt % to about 40 wt %, while sliced, or slice on slice, process cheese may have a moisture range of about 40 wt % to about 45 wt %. A moisture level of the process cheese spread products may range from about 48 wt % to about 60 wt %, such as about 50 wt % to about 60 wt %, about 52 wt % to about 60 wt %, or about 54 wt % to about 60 wt %, about 48 wt % to about 55 wt %, about 48 wt % to about 52 wt %, or about 48 wt % to about 51 wt %. In some implementations, the moisture may be derived solely from the antimicrobial-containing products, or some moisture may be added moisture (e.g., in the form of a liquid such as water, or a dairy component such as milk or cream). Moisture levels may impact product viscosity, such that the greater the moisture level, the less viscous, and vice-versa.

Salt may be included in the process cheese and process cheese spread products and the amount may depend on the desired taste and/or nutritional content of the product. For example, low-sodium varieties may include less salt than other varieties. In various embodiments, the salt content of the products may range from about 0.1 wt % to about 3 wt %, about 0.2 wt % to about 2 wt %, or about 0.3 wt % to about 0.8 wt %.

Production of process cheese loaf and process cheese spread products may use the antimicrobial-containing products alone or may combine such products with one or more of the product components described herein. For example, one or more of the antimicrobial-containing products may be subjected to a moisture removal process such as reverse osmosis or nanofiltration where some salt and minerals may also be removed. Additionally or alternatively, the antimicrobial-containing products may be fed into an evaporator vessel at the conditions described herein for removal of moisture, and the composition may be continuously transferred by blades, such as by a mutator/wiper shaft of a wiped film evaporator or a scraped surface heat exchanger, to form a thin film while maintaining the composition at the evaporation temperatures via heat transfer walls. In examples, the antimicrobial-containing product is the sole component subjected to moisture removal such as by reverse osmosis and/or evaporation.

Wiped film evaporation may help produce a finished process cheese product with a desired moisture content. For example, the antimicrobial-containing products may be concentrated to a total solids in excess of 65%, e.g., a moisture content of about 35% that is typical of standard cheddar cheese produced from conventional processes and that is traditionally used to manufacture process cheese. In some implementations, an even higher total solids intermediate may be provided, e.g., in excess of 67%, to accommodate for the downstream introduction of additional moisture when forming a final product, such as when direct steam injection is used in cooking the process cheese products.

In some implementations, additional concentration steps may facilitate the production of pasteurized process cheese, pasteurized process cheese spreads, or other similar products. For example, concentration via reverse osmosis (RO) and/or wiped film evaporation may increase the total solids of the products such that they can be used to produce process cheese and spreads. In some cases, reverse osmosis may be used alone to make a pasteurized process cheese spread, while a combination of reverse osmosis and wiped film evaporation or wiped film evaporation alone may be used to produce pasteurized process cheese. Following RO and/or wiped film evaporation, the concentrated intermediate may be subjected to further processing steps.

After moisture removal, the one or more of the antimicrobial-containing products resulting from moisture removal may be blended. Blending may be in combination with the various product components disclosed herein. For example, salt and other product components may be blended with the moisture-adjusted antimicrobial-containing products. The blended composition may be subjected to cooking and steam may be injected into the cooker, e.g., a kettle-type cooker. Optional emulsifying salts or other product components may be added to the cooker and may be further blended, for example to produce a pasteurized process cheese, spread, or product. The mixture in the cooker may be subjected to one or more heating steps described herein in connection with production of cheese sauces, and may also be subjected to one or more cooling steps.

The finished process cheese block or process cheese spread may be packaged and stored at refrigeration temperatures, e.g., about 39 °F (4 °C).

Process cheese products or the portions of such products containing the antimicrobial-containing products produced without pH-controlled fermentation, as disclosed herein, may include about 11 ppm to about 27 ppm nisin, about 12 ppm to about 20 ppm nisin, or about 13 ppm to about 20 ppm nisin and/or other antimicrobial. Process cheese products or the portions of the products containing the nisin-containing products produced with pH-controlled fermentation, as disclosed herein, may include about 24 ppm to about 41 ppm nisin, about 25 ppm to about 38 ppm nisin, or about 23 ppm to about 38 ppm nisin and/or other antimicrobial. For instance, where the process cheese product contains the antimicrobial-containing products of the present disclosure at 100%, the product may include the aforementioned ranges of nisin, while a process cheese product containing 25% antimicrobial-containing products of the present disclosure may include 25% of the aforementioned ranges of nisin.

Process cheese spreads or the portions of such spreads containing the antimicrobial-containing products produced without pH-controlled fermentation, as disclosed herein, may include about 10 ppm to about 17 ppm nisin, about 11 ppm to about 16 ppm nisin, or about 12 ppm to about 15 ppm nisin and/or other antimicrobial. Process cheese spreads or the portions of such spreads containing the nisin-containing products produced with pH-controlled fermentation, as disclosed herein, may include about 16 ppm to about 26 ppm nisin, about 17 ppm to about 25 ppm nisin, or about 18 ppm to about 24 ppm nisin and/or other antimicrobial. For instance, where the process cheese product contains the antimicrobial-containing products of the present disclosure at 100%, the product may include the aforementioned ranges of nisin and/or other antimicrobial, while a process cheese product containing 25% nisin-containing products of the present disclosure may include 25% of the aforementioned ranges of nisin and/or other antimicrobial.

### Methods of Producing Final Products

Implementations of one or more of the foregoing disclosed methods, including adjustment of milk compositions, fermentation, pH-controlled fermentation, antimicrobial (e.g., nisin) production, and enzyme treatment, may produce an intermediate product that is subjected to further processing to produce a final product. Potential final products include process cheese, cheese spreads, and cheese sauces, as disclosed above.

In methods of producing final products from the fermentate 260, e.g., lactic acid and/or antimicrobial-containing products disclosed herein, the methods may minimize the loss of desirable intermediates or byproducts of the methods. Such methods permit greater control over components of the final products. Such methods also benefit from cleaner product labels, as disclosed herein, and/or lower production costs by avoiding the addition of ingredients to final products. For example, in the disclosed methods, loss of lactic acid and/or an antimicrobial nisin may be minimized. In implementations that include enzyme treatment as disclosed herein, loss of enzymes and/or enzyme reaction products may be minimized. Some antimicrobials, enzymes, and/or enzyme reaction products may be lost during processing, such as negligible loss of antimicrobial in cooking steps through inactivation by denaturation, and the methods may not include any intentional removal of lactic acid, antimicrobial (e.g., nisin), enzymes, and/or enzyme reaction products. In some methods of producing final products from nisin-containing products, only moisture is removed.

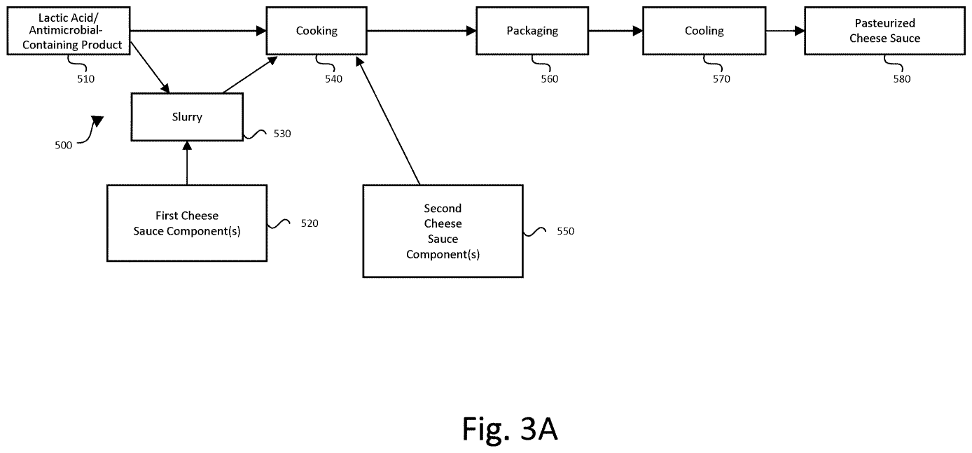

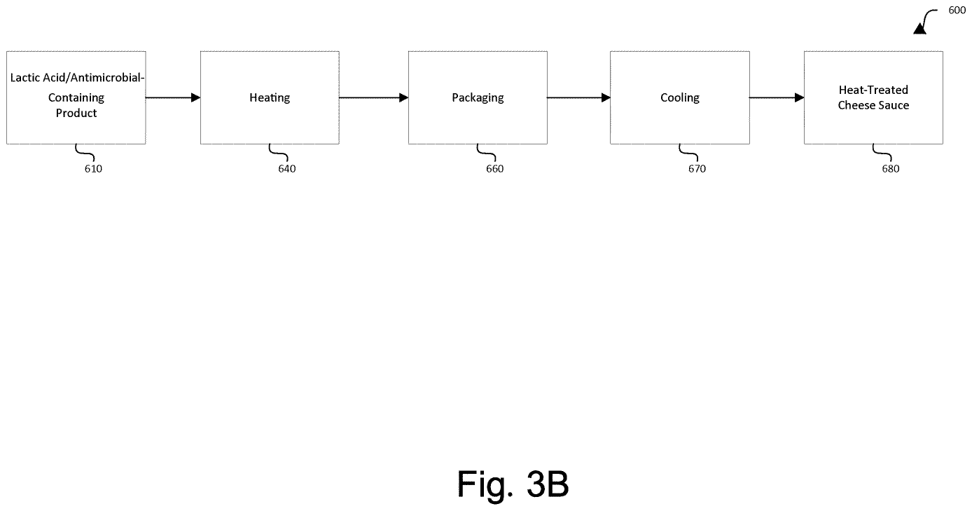

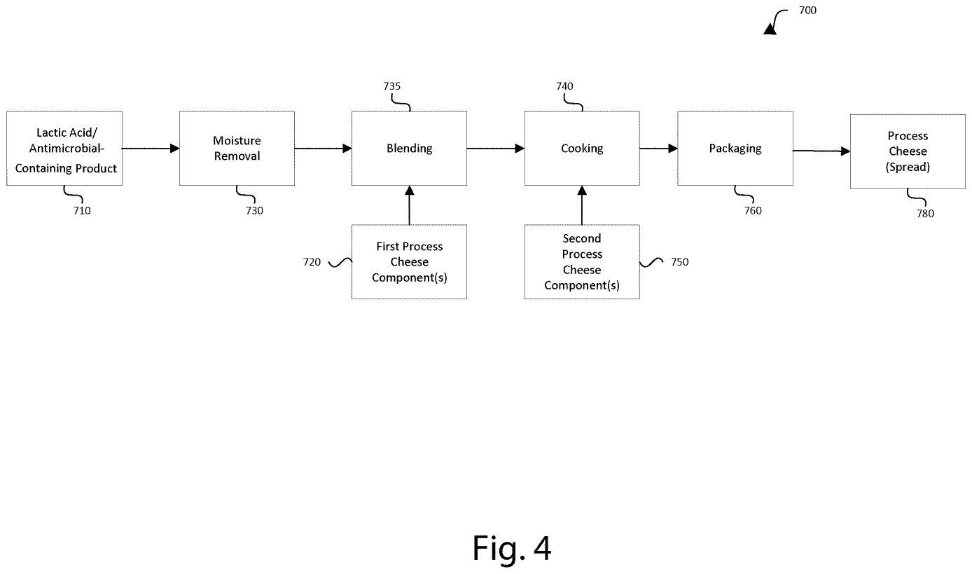

Methods of producing final products from the fermentate 260, e.g., lactic acid and/or antimicrobial-containing products disclosed herein are presented in FIGS. 3A, 3B, and 4. One method of making a pasteurized cheese sauce is presented in FIG. 3A. In the method 500, a lactic acid-containing product and/or an antimicrobial-containing product such as a nisin-containing product 510, which may be an adjusted milk composition fermentate 260 of method 100 or a combined adjusted milk composition fermentate 460 of method 300, is shown as a starting material, but the method 500 may be continuous or semi-continuous with previously disclosed methods 100, 300. The product 510 may be all or a portion of a stream that has been previously processed, such as via previously disclosed methods 100, 300. For example, a portion of the product 510 may be combined with one or more first cheese sauce components 520, which may be dry ingredients, to form a slurry 530. The product 510 may be subjected to one or more cooking steps 540, as described above. One or more second cheese sauce components 550, such as steam, emulsifying salts, and dairy derived emulsifying salts obtained from the milk composition or from a separate dairy stream, as described herein, and/or other ingredients, such as condiments, may be added before or during cooking 540. The cooked product is then packaged 560, such as via a pouch filler packing machine, and cooled 570 to produce a pasteurized cheese sauce 580.

Another method of making a cheese sauce is presented in FIG. 3B. In the method 600, as in the method 500 shown in FIG. 3A, a lactic acid-containing and optionally an antimicrobial/nisin-containing product 610 may be an adjusted milk composition fermentate 260 of method 100 or a combined adjusted milk composition fermentate 460 of method 300. The method 600 may be continuous or semi-continuous with previously disclosed methods 100, 300. The product 610 may be subjected to heat treatment 640, such as via a plate heat exchanger. Heat treatment is generally understood as heating to less than the minimum required time or heating temperature for pasteurization as defined through the mandatory pasteurization reference in the Code of Federal regulations, 21CFR1240.61, e.g., any temperature less than 161 °F. or for less than 15 seconds, or less than or equal to 145 °F for less than 30 minutes. For instance, the heat treatment may involve heating to a temperature less than 155 °F for 15 or more seconds but less than 30 minutes. One or more second cheese sauce components such as emulsifying salts, dairy derived emulsifying salts obtained from the milk composition or from a separate dairy stream, as described herein, and/or other ingredients, such as condiments, may be added before or during heat treatment 640. The heated product is then packaged 660, such as via a pouch filler packing machine, and cooled 670 to produce a heat treated cheese sauce 680. Compared to the method 500 shown in FIG. 3A, the method 600 shown in FIG. 3B may be more suitable to producing cheese sauce products where product performance may be impacted by pasteurization.

A method of making a process cheese product, such as a spread or other product, is presented in FIG. 4. In the method 700, a lactic-acid containing and optionally an antimicrobial/nisin-containing product 710, which may be an adjusted milk composition fermentate 260 of method 100 or a combined adjusted milk composition fermentate 460 of method 300, is shown as a starting material, but the method 700 may be continuous or semi-continuous with previously disclosed methods 100, 300. The product 710 may be subjected to moisture removal 730 to reduce moisture content and/or increase total solids content. Moisture removal may include one or more of reverse osmosis and evaporation, which may be wiped film evaporation, as described above. The concentrated product may then be blended 735, which may be with one or more first process cheese components 720, such as salt, as described above. The blended, concentrated product may be subjected to one or more cooking steps 740, as described herein. When the process cheese product is a pasteurized product, the cooking step 740 may involve heating for a minimum required time and temperature for pasteurization as defined through the mandatory pasteurization reference in the Code of Federal regulations, 21 C.F.R § 1240.61, e.g., a temperature of 161 °F for 15 seconds, or a temperature of 145 °F for 30 minutes. One or more second process cheese components 750, such as steam, emulsifying salts, and/or other ingredients, such as condiments, may be added before or during cooking 740. The cooked product is then packaged 760 to produce a process cheese or process cheese spread 780.

### EXAMPLES

The following examples illustrate various aspects of the disclosure and should not be considered limiting.

### Example 1—Lactic Acid Production

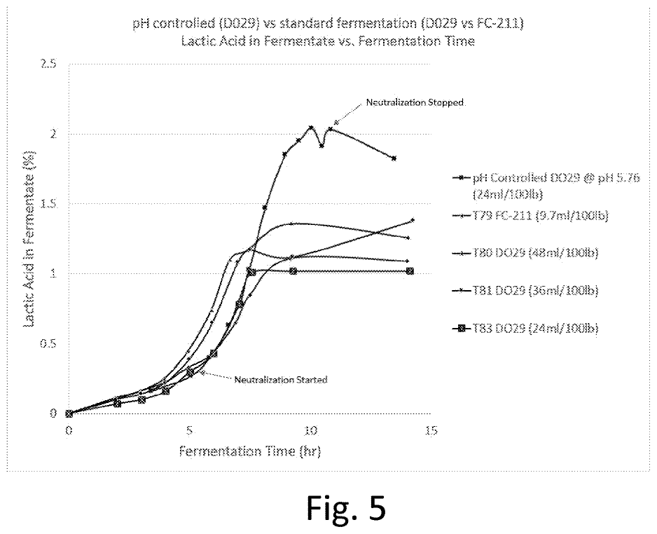

A salted microfiltered milk composition was fermented with a lactic acid-producing culture, (Lactococcus lactis subsp. cremoris and Lactococcus lactis subsp. lactis (FC-211 from DSM Food Specialties B.V.)), at 9.7 mL/100 lb. of milk composition, or with a lactic acid and antimicrobial-producing culture, (Lactococcus lactis subsp. cremoris (D 029 from CSK Food Enrichment C.V.), which is a nisin-producing culture), at each of 24, 36, and 48 mL/100 lb. of milk composition. The pH of the fermenting material was allowed to drop naturally, without intervention. The natural samples were compared to a milk composition fermented with D 029 at 24 mL/100 lb. for which the pH was maintained at about 5.76 by addition of a 10% sodium hydroxide after about 5.5 hours of fermentation using an in-line recirculation loop. Lactic acid in the fermenting material was measured for about 14 hours. Samples of the fermented material were pulled from the tank at the noted fermentation times and frozen and held for lactic acid testing. The lactic acid test conducted is Organic Acids (ORGAN-ACID)-Method: SL-0270-5307-JOC (1987) 398:265. Results are presented in FIG. 5.

The results show that lactic acid concentration in the naturally fermenting cultures 805, 810, 815, 820 (i.e., no pH control) increased exponentially over time until about 7.5-8 hours. Then lactic acid concentration roughly leveled off. The highest concentration of lactic acid obtained in the naturally fermenting cultures was about 1.4 wt % in run 820. By comparison, lactic acid concentration in the pH-controlled cultures 830 increased exponentially over time until about 10 hours, up to more than a 2 wt % lactic acid concentration. The concentration of lactic acid produced in the pH-controlled sample was up to twice that produced in the absence of pH control. When pH control was ceased after about 11 hours of fermentation, lactic acid concentration fell until the experiment was terminated. The results demonstrate that lactic acid formation during fermentation of milk compositions with nisin-producing cultures is pH-dependent, and controlling the pH maximizes lactic acid production.

### Example 2—pH and Nisin Content of Fermentates Over Time

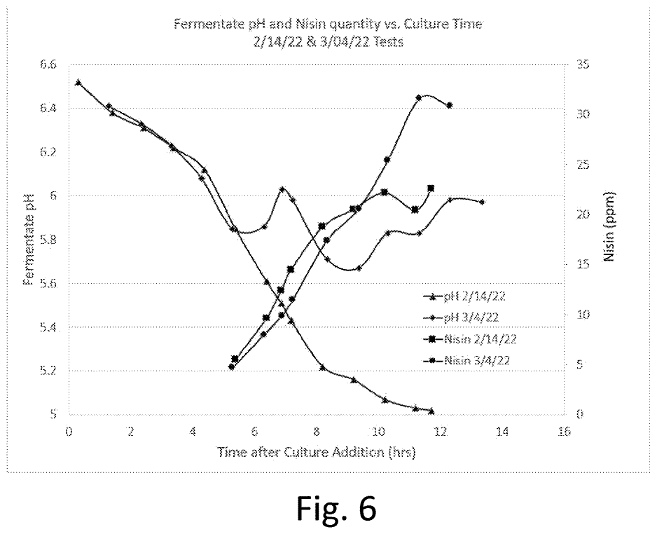

A salted microfiltered milk composition was used to produce a nisin-containing cheese sauce. The nisin producing culture, D 029, was added at 173 grams of culture for 810 lbs. of salted microfiltered milk concentrate per trial, Feb. 14, 2022 and Mar. 4, 2022. pH control was completed for the Mar. 4, 2022 run but not the Feb. 14, 2022 run. A 10% sodium hydroxide solution was used with the recirculation loop and shear pump to control pH for the Mar. 4, 2022 run. Nisin content was measured on samples pulled at the noted time-after-culture-addition points in FIG. 6 after they had been frozen and after being tested for pH. Freezing the samples was used to halt the production of nisin in the samples by the nisin-producing culture. Nisin was tested using aqueous extraction and submission into UPLC-MS/MS. Results are presented in FIG. 6.

The results show that pH fell steadily from about 6.55 to about 5.0 about 12 hours after addition of the nisin-producing culture in the absence of pH control at 905. Nisin concentration rose from about 5 ppm at about 5.5 hours after culture addition to about 22.5 ppm at about 12 hours at 910. In the pH-controlled culture sample, the pH was allowed to fall to about 5.85 and then was maintained between about 5.65 and 6.0 at 915. Nisin concentration increased steadily until about 11 hours after addition of the culture to a maximum of about 32 ppm at 920. The results demonstrate that nisin production in fermented milk compositions is pH dependent, and controlling the pH during fermentation increases nisin production compared to no pH control.

### Example 3—Nisin Content of Cheese Sauce

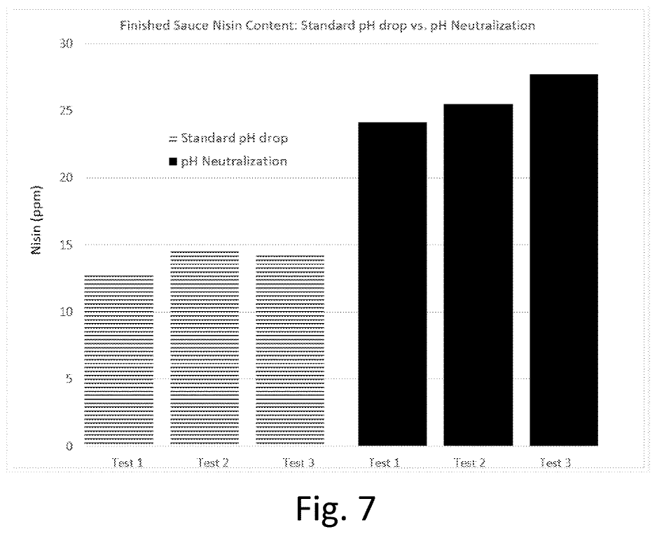

A milk composition of 44.59% solids was fermented with a nisin-producing culture, D 029, at 19.25 mL/100 lb. of milk composition. The pH of the fermenting material was allowed to drop to around pH 5 to produce a fermentate. The fermentate was used in a cheese sauce formulation that comprised of 84.14% fermentate, 1.2% nonfat dry milk, 0.57% salt, 0.09% lactic acid, 0.2% sorbic acid, 0.1% xanthan gum, 4.73% of a sodium phosphate mixture, and 8.97% water. Dry ingredients were hydrated within the fermentate and added to a 50 lb. laydown twin screw auger cooker, along with the remaining ingredients except for the sodium phosphate mixture. The combined materials were blended at 82 rpm initially for 30 seconds. Direct steam addition into the cooker with mixing was maintained until the mass reached a temperature of 125 °F. The sodium phosphate solution was reacted in a separate vessel and added directly to the cooker once the molten mass reached 125 °F. Once added, the cooker continued to cook until 165 OF was reached and then held in the cooker for 1 min. to achieve pasteurization. Once the time and temperature combination was achieved, the product was hot filled into plastic pouches and a 4 oz. vial for nisin testing. Product was filled into pouches and vials were placed under refrigeration to cool. Vials were tested for nisin through aqueous extraction and submission into UPLC-MS/MS. For the pH control testing, the same milk composition described above was subjected to pH-control using a 10% sodium hydroxide solution in a continuous process, instead of the cooker, where the fermentate was heated to 165 °F for 30 seconds and sampled were pulled from the beginning, middle and end of the continuous run per experiment. Three sauces were produced using the same standard pH drop fermentate and pH neutralization and tested separately for nisin. Nisin content of the resulting cheese sauce was measured. Results are presented in FIG. 7.

The results show an average of about 13 ppm nisin in the cheese sauce produced from the naturally fermented cultures (i.e., no pH control) at 1000, 1005, 1010. The results show an average of about 26 ppm nisin in the cheese sauce produced from the pH-controlled fermentates at 1015, 1020, 1025. The results demonstrate that nisin production in fermented milk compositions is pH dependent, and controlling the pH during fermentation results in finished products having approximately double the concentration of nisin than in the absence of pH control.

### Example 4—Shelf-Life Testing #1 of Nisin-Containing Cheese Sauce

An adjusted milk composition with 42.95% solids was fermented with a nisin-producing culture, D 029, at 22.95 mL/100 lb. of milk composition. A second fermentation was conducted at the same time with an adjusted milk composition of 42.95% solids with the non-nisin producing culture, FC-211 at 9.7 mL/100 lb. The pH of the fermenting material was allowed to drop to around pH 5 over 12 hours. To obtain various levels of nisin-developed fermentate, a ratio of fermentate from the nisin-producing culture, D 029, and non-nisin producing culture, FC-211, were used to feed the fermentate portion of the final sauce. The ratios of D 029 fermentate to FC211 fermentate were 75:25, 50:50, 25:75, 6.25:93.75, and 0:100.

The ratio of fermentate was used in a sauce formulation that comprised of about 85.1% fermentate, 1.19% nonfat dry milk, 0.09% lactic acid, 0.1% xanthan gum, 4.73% of a sodium phosphate mixture, and 8.79% water. Dry ingredients were hydrated within the fermentate and added to a 14 lb. laydown twin screw auger cooker, along with the remaining ingredients except for the sodium phosphate mixture. The mixture was blended at 32 rpm initially for 30 seconds. Direct steam addition into the cooker with mixing was maintained until the mass reached a temperature of 125 °F. The sodium phosphate mixture was prepared in a separate vessel and added directly to the cooker once the molten mass reached 125 °F. Once added, the cooker continued to cook until 165 °F. was reached and then held in the cooker for 1 min. to achieve pasteurization temperatures. Once the time and temperature combination was achieved, the product was hot filled into plastic pouches and a 4 oz. vial for nisin testing. Product filled into pouches and vials were placed under refrigeration to cool. Vials were tested for nisin by UPLC-MS/MS as shown in Table 2.

An accelerated challenge study was conducted of the 5 sauces with Bacillus cereus to determine susceptibility of microbial outgrowth over 72 hours at 30 °C. The product was inoculated with B. cereus. The inoculated subsamples were tested immediately after inoculation (Time 0 h) and at Day 1, Day 2, and Day 3. The product was held at 30±1 °C for 72 hours. Results in Table 3 showed less than 1.0 log CFU/g growth B. cereus was observed in a cheese sauce 75% D 029: 25% FC211, 50% D 029: 50% FC211, 25% D 029: 75% FC211, 6.25% D 029:93.75% FC211, and 0% D 029: 100% FC211 samples when held at 30±1 °C for 72 hours.

TABLE 2

| | 75% | 50% | 25% | 6.25% | 0% |
|---|---|---|---|---|---|
| | D029:25% | D029:50% | D029:75% | D029:93.75% | D029:100% |
| | FC211 | FC211 | FC211 | FC211 | FC211 |
| pH | 6.22 | 6.14 | 6.10 | 6.15 | 6.12 |
| Fat % | 20.10 | 20.26 | 20.09 | 20.34 | 20.12 |
| Moisture % | 60.73 | 60.88 | 61.06 | 60.55 | 60.99 |
| Salt % | 1.01 | 0.99 | 1.00 | 1.01 | 1.00 |
| Water Activity | 0.972 | 0.972 | 0.973 | 0.971 | 0.974 |
| Lactose | 0.59 | 0.57 | 0.59 | 0.41 | 0.61 |
| Nisin ppm | 8.8 | 7.6 | 5.1 | 2.2 | 1.2 |
| (LOL) | | | | | |

TABLE 3
Log change of B. cereus counts in sauce held over 72 hours.

| | 75% | 50% | 25% | 6.25% | 0% |
|---|---|---|---|---|---|
| | D029:25% | D029:50% | D029:75% | D029:93.75% | D029:100% |
| | FC211 | FC211 | FC211 | FC211 | FC211 |
| Day 1 | −1.4 | −0.9 | −0.9 | −1.2 | −0.5 |
| Day 2 | −1.2 | −1 | −0.1 | −0.5 | 0.3 |
| Day 3 | −0.7 | −0.7 | −1 | −0.8 | 0.8 |

### Example 5—Shelf-Life Testing #2 of Nisin-Containing Cheese Sauce

The 50% D029: 50% FC211 fermentate sauce product produced from Example 4 was selected to be placed in a long-term challenge study with Clostridium species to determine susceptibility to microbial outgrowth over 36 weeks at 7 °C. (44.6 °F.) and a cooling profile study with Bacillus cereus and C. sporogenes.

For the B. cereus and C. sporogenes cooling challenge, the product was inoculated with B. cereus and C. sporogenes and heat shocked at 80 °C for 10 minutes. The C. sporogenes samples were then opened and placed in anaerobic jars for the cooling portion. The inoculated subsamples were tested immediately after heat treatment (Time 0 h) and at Day 1 and Day 2. The product was cooled to from 176 °F to 45 °F over 2 days. Growth over the two days were recorded as less than 1.0 log CFU/g of B. cereus and C. sporogenes when cooled to 15.5 °C (59.9 °F), which supports that nisin at 7.6 ppm level associated with this specific sauce composition can control the growth of these two organisms.

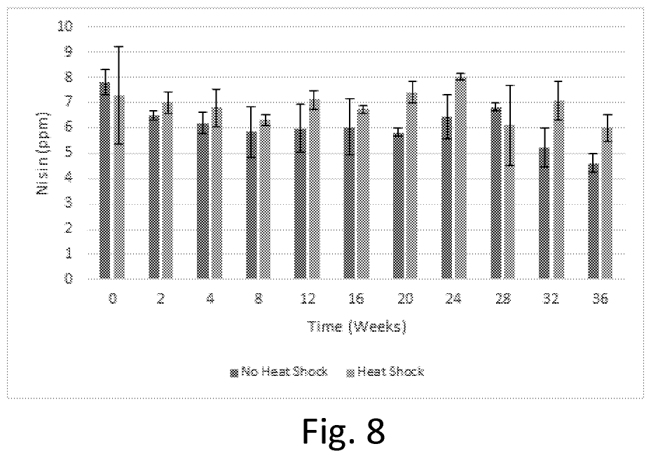

For the long-term C. sporogenes challenge, the 50% D029: 50% FC211 fermentate sauce were subsequently heat shocked at 60 °C for 30 minutes. The samples were then opened and placed in anaerobic jars for the shelf-life portion of the study. The inoculated subsample was tested immediately after inoculation or heat shock (Time 0 h) and at Week 2, Week 4, Week 8, Week 12, Week 16, Week 20, Week 24, Week 28, Week 32, and Week 36 at 7±1 °C. (44.6 °F.). Over the course of 36 weeks, less than 1.0 log CFU/g Clostridium spp. growth was recorded in the 50% D 029: 50% FC211 fermentate sauce sample at 7 °C. These results support an initial 7.6 ppm nisin with its associated sauce composition can control Clostridium spp. growth. FIG. 8 is a chart showing amounts of nisin (ppm) in uninoculated 50% D 029: 50% FC211 fermentate Sauce samples with and without a 60 °C. heat shock for 30 minutes held at 7±1 °C. over 36 weeks.

### Example Production of a Cheese Sauce with Enzyme Treatment and without Emulsifying Salts

An adjusted milk composition 165 of method 100 in the amount of approximately 800 lbs. containing 43.17% total milk solids, 14.72% milk protein, 25.37% milk fat and 17.8% milk solids nonfat was produced. Salt was added to the adjustment milk composition in the amount of 9.54 lbs. 173 grams of a nisin-producing culture were added to the salted adjusted milk composition and the fermentation process was started and the material was held at 86F for the fermentation process. The pH of the adjusted milk composition fermentate 260 was monitored until the pH reached approximately 5.85. At the point of the nisin-producing culture addition, 480 grams of a phospholipase A1 was added to the adjusted milk composition. Once the adjusted milk composition fermentate reached a pH of 5.85, a 10% sodium hydroxide solution was injected into a discharge stream from the bottom of the fermentation tank via a peristaltic pump and into a shear pump for dispersion. The neutralized adjusted milk composition fermentate was administered from the shear pump back into the top of the fermentation tank. The addition of the 10% sodium hydroxide solution for pH control purposes lasted approximately 6.5 hours until there were signs that the lactose was fully metabolized by the nisin-producing culture (i.e., an increase in pH was observed such that the added sodium hydroxide solution was no longer neutralizing the lactic acid being formed in adjusted milk composition fermentate). Approximately 40 lbs. of the 10% sodium hydroxide solution were added to the adjusted milk composition fermentate for the neutralization process. Once the neutralization process was completed the enzyme treated adjusted milk composition fermentate was heat treated. A plate heat exchanger and a hold tube of 1,130″ linear inches with an inside diameter of 1.375″ was used. The flow rate and product temperature through the hold tube of 7.26 gallons was 15 gallons per minute and 170 degrees Fahrenheit. The heat-treated cheese sauce was packaged in 5 lb. pouches and cooled on baker's trays and racks in a cooler <45 degrees Fahrenheit. The heat-treated cheese sauce had a surprisingly low viscosity compared to heat treated cheese sauce that typically contains emulsifying salts and was likely attributed to the phospholipase enzyme. The low viscosity characteristic might be leveraged to prepare high solids and/or high protein cheese sauces.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates, or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. In some instances, the term “about” includes values up to and including 10% less than and 10% greater than the recited value.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of producing a dairy product, the method comprising:
adjusting a composition of milk such that an adjusted milk composition contains at least one of a reduced protein-to-fat ratio or a reduced lactose-to-fat ratio relative to the composition of the milk; and
fermenting the adjusted milk composition to cause in situ production of lactic acid during a fermentation period of about 4 hours to about 22 hours,
wherein during the fermentation period, a pH range of about 5.5 to about 5.9 is maintained by adding a pH adjuster to the fermenting adjusted milk composition, and
wherein more lactic acid is produced during the fermentation period than in the absence of maintaining the pH range at about 5.5 to about 5.9.

2. The method of claim 1, wherein the pH is maintained at about 5.7 to about 5.9.

3. The method of claim 1, wherein the pH adjuster is at least one of a sodium hydroxide solution or a potassium hydroxide solution.

4. The method of claim 1, wherein prior to adding the pH adjuster, a portion of the fermenting adjusted milk composition is withdrawn and combined with the pH adjuster and the combination is added to a remaining portion of the fermenting adjusted milk composition via an in-line recirculation loop.

5. The method of claim 1, wherein during the fermenting, an antimicrobial is produced by an antimicrobial-producing culture.

6. The method of claim 5, wherein more antimicrobial is produced during the fermentation period than in the absence of maintaining the pH range at about 5.5 to about 5.9.

7. The method of claim 5, wherein the antimicrobial-producing culture comprises a nisin-producing culture, and wherein during the fermenting, nisin is produced at a level of about 4 ppm to about 35 ppm.

8. The method of claim 5, wherein the antimicrobial-producing culture is the sole preservative in the dairy product.

9. The method of claim 1, wherein during the fermenting, the lactic acid is produced at a level of about 0.25 wt % to about 2.3 wt %.

10. The method of claim 1, wherein the lactic acid is produced by at least one nisin-producing culture.

11. The method of claim 1, wherein the lactic acid is produced by both a nisin-producing culture and a starter culture.

12. The method of claim 1, wherein the adjusted milk composition is a microfiltration concentrate having the reduced protein-to-fat ratio.

13. The method of claim 1, wherein prior to or during the fermenting, lactose is added to the adjusted milk composition.

14. The method of claim 1, wherein prior to the fermenting, the adjusted milk composition is salted.

15. The method of claim 1, wherein prior to the fermenting, the adjusted milk composition is heat treated to a temperature of about 155 °F to about 175 °F and then cooled to a temperature of about 70 °F to about 94 °F.

16. The method of claim 1, wherein the dairy product is free of emulsifying salts.

17. A method of producing a dairy product, the method comprising:
adjusting a composition of milk such that an adjusted milk composition contains at least one of a reduced protein-to-fat ratio or a reduced lactose-to-fat ratio relative to the composition of the milk; and
fermenting the adjusted milk composition to cause in situ production of lactic acid during a fermentation period of at least about 4 hours,
wherein during the fermentation period, a pH range of about 5.5 to about 5.9 is maintained by adding a pH adjuster to the fermenting adjusted milk composition.

18. The method of claim 17, wherein the adjusted milk composition is a microfiltration concentrate having the reduced protein-to-fat ratio.

19. The method of claim 18, wherein at least a portion of whey has been removed from the adjusted milk composition.

20. The method of claim 17, wherein prior to adding the pH adjuster, a portion of the fermenting adjusted milk composition is withdrawn and combined with the pH adjuster, and the pH-adjusted combination is added to a remaining portion of the fermenting adjusted milk composition.
